(19) United States
(12) Patent Application Publication
(10) Pub. No.: US 2012/0200859 A1
(43) Pub. Date: Aug. 9, 2012

(54) FREQUENCY-DOMAIN OCT

(76) Inventors: Joerg BREITENSTEIN, Zollikofen (CH); Rudolf Waelti, Schwarzenburg (CH)

(21) Appl. No.: 13/241,622

(22) Filed: Sep. 23, 2011

(30) Foreign Application Priority Data
Feb. 4, 2011 (CH) 210/11

(51) Int. Cl. G01B 9/02

(52) U.S. Cl. 356/479

(57) ABSTRACT

A device for establishing geometric values at least from a first region (MB1) and from a second region (MB3), distanced from the first region (MB1), of a transparent or diffusive object, comprises a coherence tomograph with an object arm, a reference arm, a detector arm, and a light source (ALQ) for emitting light. The device has a first path, formed by the object arm and/or the reference arm, having a first optical path length and a second path having a second optical path length, along which the light emitted by the light source (ALQ) can propagate.

### TECHNICAL FIELD

The invention relates to a device and a method for establishing geometric values at least from a first region and from a second region, distanced from the first region, of a transparent or diffusive object, comprising a coherence tomograph with an object arm, a reference arm, a detector arm, and a light source for emitting light.

### PRIOR ART

The present invention relates to a method and a device for establishing geometric values from at least two regions that are distanced from one another in a transparent or diffusive object, in particular for establishing layer thicknesses and lengths and/or surface curvatures (topography) as geometric values. Geometric values are understood to mean e.g. layer thicknesses, distances, lengths, and topographies.

The underlying principle of OCT is based on interferometry. This method compares the run time of a signal with the aid of an interferometer (usually a Michelson interferometer). In the process, the one arm with a known optical path length is used as a reference arm for the measurement arm.

The signal interference (optical cross correlation) from both arms results in a pattern from which it is possible to read out the relative optical path length within a depth profile (amplitude-mode scan). In the one-dimensional scanning method, the beam is then guided transversally in one or two directions, by means of which it is possible to record a planar tomogram (brightness-mode scan) or a three-dimensional topography (c-mode scan).

OCT is very prevalent in ophthalmology in particular, which can inter alia be traced back to the fact that the depth resolution is decoupled from the transversal resolution and that it permits contactless in vivo measurements. Further advantages emerge in the case of light-sensitive bodies, as e.g. in the case of measurements in the eye, as a result of the low power required for the measurement.

The known devices for establishing geometric values are disadvantageous in that they have relatively low measurement speeds and signal-to-noise ratios. Moreover, the design is relatively complex and hence expensive. Finally, the measurement regions are often unsatisfactory.

### DESCRIPTION OF THE INVENTION

The object of the invention is to develop a device, which belongs to the technical field mentioned at the outset, for establishing geometric values by means of a coherence tomograph, which device, compared to the known instruments, is distinguished by higher measurement speeds and a greater measurement region.

The solution to the object is defined by the features of claim 1. According to the invention, the device has a first path, formed by the object arm and/or the reference arm, having a first optical path length and a second path having a second optical path length, along which the light emitted by the light source can propagate.

It is true that the coherence length of the tunable laser line corresponds to the measurement depth in the object. Since the coherence length of the tunable light source is limited, the measurement depth is also limited. The human axis length of at most approximately 34 mm is longer than the coherence length of most currently commercially available tunable light sources. It is for this reason that an axis length of 34 mm cannot be measured by most tunable light sources that are available today without the use of further measures. According to the invention, a measure that allows the measurement of axis lengths of at most approximately 34 mm is now proposed; to be precise, this is the subdivision of the measurement region into two measurement regions (depth-scan regions) that are distanced from one another and respectively correspond to the aforementioned first path and second path. It goes without saying that provision can also be made for more than two measurement regions that are distanced from one another. The two regions that are distanced from one another are referred to as anterior and posterior measurement region in the following text.

The first path having the first optical path length and the second path having the second optical path length can be obtained by different methods. Thus, for example, a displaceable mirror may be provided on precisely one optical arm (reference arm or object arm). Displacing the mirror thus allows a switch to be made from a first path length to a second path length. Since, depending on the embodiment, the mirror may also adopt more than two positions, it could in principle also be possible for a plurality of optical path lengths to be set; more particularly, in the case of a continuous setting option, it could also be possible to set an arbitrary number of optical path lengths. In further embodiments the object or reference arm may also comprise a mirror which can be pivoted in or out, as a result of which the two path lengths can be set. In this respect, a person skilled in the art is also aware of further options.

Furthermore, the two optical path lengths may also be provided separately, respectively by their own optical arm.

In order to deflect the light from a first arm to a second arm, provision is preferably made for a scanner mirror, which can conduct the light beam through the first arm in a first position and can conduct the light beam through the second arm in a second position. Furthermore, the light can also be routed from one arm to the other by means of a scanner mirror, more particularly a galvanometer mirror, a fiber-optic switch, or a liquid crystal. In order to compensate for dispersions, a glass substrate may be provided in a reference arm. This can increase the interference signal from the retina. A dispersion compensator may also be dispensed with in some variants.

The device preferably comprises a focus switch in the object arm. This switch can be used to focus on both regions. If the light successively passes through two arms, the focus is preferably switched synchronously with the switch from the first path having the first optical path length to the second path having the second optical path length. The focus switch may also be embodied as an optical element which can be pivoted in. A person skilled in the art also knows of further options in this respect, for example a lens that has different focal lengths depending on the orientation.

The device can furthermore have a camera that can be fed with visible light via a wavelength-selective beam splitter. The advantage of this is that the wavelengths (e.g. infrared) required for the OCT measurement are not attenuated, or only attenuated insignificantly. This camera is preferably placed in the region of the object to be measured. As a result, an anterior side of the object, more particularly of the eye, can be recorded and displayed on a screen. A user is thus able to position the measurement instrument, for example by means of a cross slide.

The device can furthermore comprise an optical element for projecting a pattern onto the object. This optical element may for example be embodied as a cone or hemisphere and the pattern may be provided as an annular pattern, which can be recorded by means of a camera. As a result, it is possible, for example, to calculate the shape of the surface of the tear film on an eye in order to use this established data in turn to optimize the measurement accuracy of the OCT measurement.

Light with the same wavelength is typically used for the anterior region and the posterior region. Light with different wavelengths may be used for the anterior region and the posterior region in some variants. As a result, the power may be adjusted depending on the sensitivity of the regions of the object, more particularly the eye, as a result of which it is possible to increase a sensitivity. On the other hand, this embodiment may be disadvantageous in that the device becomes more expensive and more complicated in its design. To this end, the device may comprise wavelength-selective beam splitters and, if need be, a plurality of light sources.

A coherence tomograph comprising an object arm, a reference arm, a detector arm, and a light source for emitting light is used in the method for establishing geometric values at least from a first region and from a second region, distanced from the first region, of a transparent or diffusive object. In order to establish the geometric value of the first region, the light from the light source is guided over a first path having a first optical path length in the object arm and/or the reference arm. In order to establish the geometric value of the second region, the light from the light source is guided over a second path having a second optical path length in the object arm and/or the reference arm.

The coherence tomograph is preferably embodied as a frequency-domain OCT, more particularly as an SSOCT (swept source OCT) or as a spectral OCT.

Thus, use is preferably made of an optical coherence tomograph in the frequency domain, for example in the geometric design of a Michelson interferometer. This interference method is called frequency-domain OCT (OCT being an acronym for optical coherence tomograph). In contrast to time-domain OCT, which has existed for a relatively long time, it has the property that a depth measurement is possible without a moveable reference arm and that the depth assignment of the signals reflected by the measurement object is brought about by a beat frequency.

There are two variants of frequency-domain OCT:
1. One variant consists in using a tunable light source, which changes its wavelength periodically (swept source OCT, SSOCT, or wavelength-tuning OCT). The tunable light source emits a narrow spectral line (laser line), which is pushed to and fro through a tuning range with a specific time period. In the process, the measurement region in the depth of a measurement object is given by the line width of the tunable laser line. The repetition rate of the measurements through a measurement object is given by the time period of the tuning. The temporal beat signal, which is created by interference of the laser line reflected from the reference arm and object arm, can be detected once per tuning period with a photodiode.
2. The other method is called spectral OCT, in which use is made of a light source with a time-unchanging spectrum. A spectrometer is required for the detection in order to record the spectral beat signal in a wavelength-dependent fashion. In the process, the measurement region in the depth is given by the resolution of the spectrometer. The repetition rate of the measurements through the measurement object is given by the readout speed of the line detector used in the spectrometer.

Since the light backscattered from the measurement object and from the reference arm generates a beat signal with a frequency proportional to the depth in both of these frequency-domain methods, the scatter amplitudes can be calculated at any depth by means of a Fourier transform. Frequency-domain OCT allows higher measurement speeds and a better signal-to-noise ratio than time-domain OCT. However, a disadvantage of the frequency-domain OCT is that the signal amplitude reduces with the measurement depth.

In order to obtain pronounced interference signals even in the case of only weakly reflecting layers in the object arm, the measurement radiation is preferably focused successively in terms of time in the anterior and in the posterior measurement region. Shifting the focus from the anterior to the posterior measurement region occurs synchronously, for example with the change in the reference arm used for the measurement if use is made of two reference arms or synchronously with the jump in the optical path length in the reference arm if use is made of only one reference arm. A person skilled in the art is also aware of further options.

The geometric value is preferably a layer thickness, a length, a surface curvature, and/or a topography of the object. The device for establishing layer thicknesses and lengths and/or surface curvatures (topography) as geometric values. Geometric values are understood to mean e.g. layer thicknesses, distances, lengths, and topographies. Thus, in principle, a geometric value may be a point or vector in a preferably three-dimensional, e.g. Cartesian, coordinate system. The point or vector may also have a higher dimension, wherein one component of the vector may be e.g. a wavelength, a polarization, etc. It goes without saying that the geometric value may also comprise a multiplicity of points, vectors, layer thicknesses, lengths, surface curvatures, and/or topographies of the object. A person skilled in the art is also aware of further geometric values that can be established by means of this device.

The object arm preferably comprises a focus switch. If the device comprises two object arms, with the light propagating alternately in these object arms, the foci can be obtained by a suitable lens selection. However, if two different optical path lengths should be obtained in one object arm, the focus switch may be embodied as a liquid lens or a liquid crystal.

In some variants the focus switch may also be dispensed with, particularly if objects are measured in which a change in the focus is not required.

The first region is preferably an anterior region of an eye, more particularly the anterior side of the cornea, and the second region is preferably a posterior region of the eye, more particularly the retina.

However, it is clear to a person skilled in the art that other objects (skin or reflecting bodies in general) that are not eyes, or different regions of the eye, more particularly e.g. the vitreous humor of the eye in general, etc. may also be examined.

In the following paragraphs, five types (1st type to 5th type) are used to describe how the different depth scan regions can be produced.

### 1st Type

The first path having the first optical path length is preferably given by a first object arm and the second path having the second optical path length is preferably given by a second object arm. Here, the device in this embodiment more particularly comprises precisely one reference arm.

It is obvious to a person skilled in the art that the device may also comprise more than two, e.g. three, object arms.

In the corresponding method, the light is preferably successively guided into the first object arm with the first path having the first optical path length and into the second object arm with the second path having the second optical path length. By way of example, the light can be conducted in turns, i.e. alternately, into the two arms.

Thus, the light from the light source alternately propagates in two object arms with different lengths, wherein use is preferably made of one reference arm. The difference in the optical length of the two object arms corresponds to the optical distance between the two regions that are distanced from one another.

The optical arms may have polarization controllers, by means of which the polarization of the light from the reference arms may be adjusted to the polarization of the light in the object arm.

The reference and object arm can furthermore comprise a rotatable element, which consists of a rotational axis, a semicircular glass plate, a semicircular absorber, and a semicircular hole. The rotatable element may alternately, in each case during half a revolution, activate a first and a second optical arm by either absorbing the respective light beam by the absorbing material of the rotatable element or by transmitting said light beam through the hole in the rotatable element.

The focus is preferably displaced synchronously with the measurement distance. The object arms differ in terms of the refractive indices of the optical systems therein and in terms of their lengths. An X- and a Y-scanner are preferably used together by the object arms, as a result of which an efficient and cost-effective device with a simple design is obtained. The X- and the Y-scanner may be implemented by two separate scanners, but also by a single scanner.

### 2nd Type

In a further preferred embodiment, the first optical path length is given by a first reference arm and the second optical path length is given by a second reference arm.

In the corresponding method, the light is preferably successively guided in a first reference arm with the first path having the first optical path length and in a second reference arm with the second path having the second optical path length, wherein the light can once again be conducted e.g. alternately into the two reference arms.

Thus, the light from the light source alternately propagates in two reference arms with different lengths, wherein use is preferably made of one object arm. The difference in the optical length of the two reference arms corresponds to the optical distance between the two regions that are distanced from one another.

### 3rd Type

In a further preferred embodiment, the first optical path length is given by a first reference arm and the second optical path length is given by a first object arm and a third optical path length is given by a second reference arm and a fourth optical path length is given by a second object arm. In this case, respectively one reference arm and one object arm are preferably used as a pair.

In the corresponding method, the light is preferably guided in a first reference arm with the first path having the first optical path length and in a first object arm with the second path having the second optical path length, and subsequently in a second reference arm with a third path having the third optical path length and in a second object arm with a fourth path having the fourth optical path length. Hence the first reference arm and the first object arm form a pair, in which the light is guided in succession. The light can subsequently be guided in a second pair of optical arms, namely in the second object arm and second reference arm.

In a preferred embodiment, a rotatable mirror can act as both distance and focus switch by influencing the reference beam and the object beam with this mirror. This brings about a particularly simple and compact design of the device.

### 4th Type

The device preferably comprises an object arm or a reference arm with an optical element which can be pivoted in or out, wherein the first optical path length is given when the optical element is pivoted in and the second optical path length is given when the optical element is pivoted out. In this case the focus switch may for example be embodied as a liquid lens or as a liquid crystal.

In the corresponding method, preferably, an optical element is pivoted in and pivoted out in the object arm or in the reference arm, and so a first path having the first optical path length is set when the optical element is pivoted in and a second path having the second optical path length is set when the optical element is pivoted out, wherein the light is successively, more particularly alternately, guided in the first path and in the second path. The optical element may be embodied as e.g. a mirror.

Thus, the light from the light source is conducted into a single arm (a reference arm or an object arm), which, successively in time, has two different path lengths. The optical change in the arm length corresponds to the optical distance between the two regions that are distanced from one another.

Here the optical element may be formed from a prism and a glass plate, by means of which the focus and the measurement region can be synchronously switched to and fro between the anterior eye segment and the posterior eye segment.

The reference arm and object arm may also comprise a rotatable element in this embodiment, which rotatable element consists of a rotational axis, a semicircular glass plate, a semicircular absorber, and a semicircular hole. The rotatable element may alternately, in each case during half a revolution, activate a first and a second optical arm by either absorbing the respective light beam by the absorbing material of the rotatable element or by transmitting said light beam through the hole in the rotatable element. Moreover, the rotatable element may insert a glass plate into the beam path in the object arm during half a revolution.

### 5th Type

The device preferably has a first arm having a first optical path length and a second arm having a second optical path length, wherein the first and the second arm are respectively embodied as object arm or reference arm, and wherein one arm comprises an optical transformation element for selecting a property of the light, more particularly the wavelength or the polarization, and wherein the detector arm comprises an optical separation apparatus that corresponds to the optical transformation element.

In the corresponding method, the light is preferably simultaneously conducted into two arms, more particularly an object arm and reference arm, with different optical path lengths, wherein one optical property of the light, more particularly the polarization or the wavelength, in a first arm differs from the same optical property in the second arm and wherein the light is separated in the detector arm by means of an optical separation apparatus on the basis of said optical property.

Thus the light from the light source is simultaneously conducted into two arms of different length, wherein the light in the one arm differs from the light in the other arm in terms of a specific property (more particularly in the polarization or wavelength). In this case, a suitable separation apparatus makes it possible for the light with different properties to pass over paths with different lengths in the reference or object arm. Moreover, a suitable separation apparatus in the detection arm makes it possible for the two interferences to be routed to different detectors.

A polarizing beam splitter cube may be provided in the beam path in order to be able to control the polarization.

Further advantageous embodiments and feature combinations of the invention emerge from the following detailed description and the entirety of the patent claims.

### BRIEF DESCRIPTION OF THE DRAWINGS

In the drawings used to explain the exemplary embodiment:

FIG. 1 shows a 1st embodiment variant of the device for establishing geometric values, which device is of the second type with two reference arms;

FIG. 2 shows a 2nd embodiment variant of the device for establishing geometric values, which device is of the second type with two reference arms;

FIG. 3 shows a 3rd embodiment variant of the device for establishing geometric values, which device is of the fourth type with a single reference arm, which successively in time has different path lengths;

FIG. 4 shows a 4th embodiment variant of the device for establishing geometric values, which device is of the second type with two reference arms and is based on spectral OCT;

FIG. 5 shows a 5th embodiment variant of the device for establishing geometric values, which device is of the second type with two reference arms and is based on SSOCT;

FIG. 6 shows a 6th embodiment variant of the device for establishing geometric values, which device is of the second type with two reference arms and three liquid lenses;

FIG. 7 shows a 7th embodiment variant of the device for establishing geometric values, which device is of the second type with two reference arms and two liquid crystals;

FIGS. 8a, 8b show an 8th embodiment variant of the device for establishing geometric values, which device is of the first type with two object arms and a mirror switch;

FIGS. 9a, 9b show a 9th embodiment variant of the device for establishing geometric values, which device is of the first type with two object arms;

FIG. 10 shows a 10th embodiment variant of the device for establishing geometric values, which device is of the fifth type, wherein the light is simultaneously conducted into two arms, wherein the light in the two arms differs in terms of the polarization;

FIGS. 11a, 11b show an 11th embodiment variant of the device for establishing geometric values, which device is of the third type with two pairs of an object and reference arm;

FIGS. 12a, 12b show a 12th embodiment variant of the device for establishing geometric values, which device is of the second type with two reference arms;

FIGS. 13a, 13b show a 13th embodiment variant of the device for establishing geometric values, which device is of the fourth type with a single reference arm, which successively in time has different path lengths;

FIG. 14 shows a 14th embodiment variant of the device for establishing geometric values, which device is of the second type with two reference arms;

FIG. 15 shows a 15th embodiment variant of the device for establishing geometric values, which device is of the fifth type, wherein the light is simultaneously conducted into two arms, wherein the light in the two arms differs in terms of the wavelength;

FIG. 16 shows a 16th embodiment variant of the device for establishing geometric values, which device is of the fifth type, wherein the light is simultaneously conducted into two arms, wherein the light in the two arms differs in terms of the wavelength;

FIGS. 17a, 17b show a lens with a variable focal length;

FIGS. 18a, 18b show a schematic illustration of the two foci achieved by a switchable beam restriction;

FIGS. 19a-19c show a 17th embodiment variant of the device for establishing geometric values, which device is of the first type with two object arms;

FIG. 20 shows an 18th embodiment variant of the device for establishing geometric values, which device is of the first type with two object arms;

FIGS. 21a, 21b show a 19th embodiment variant of the device for establishing geometric values, which device is of the first type with two object arms; and

FIGS. 22a-22c show a 20th embodiment variant of the device for establishing geometric values, which device is of the first type with two object arms.

In principle, identical parts in the figures are provided with the same reference sign.

### WAYS OF IMPLEMENTING THE INVENTION

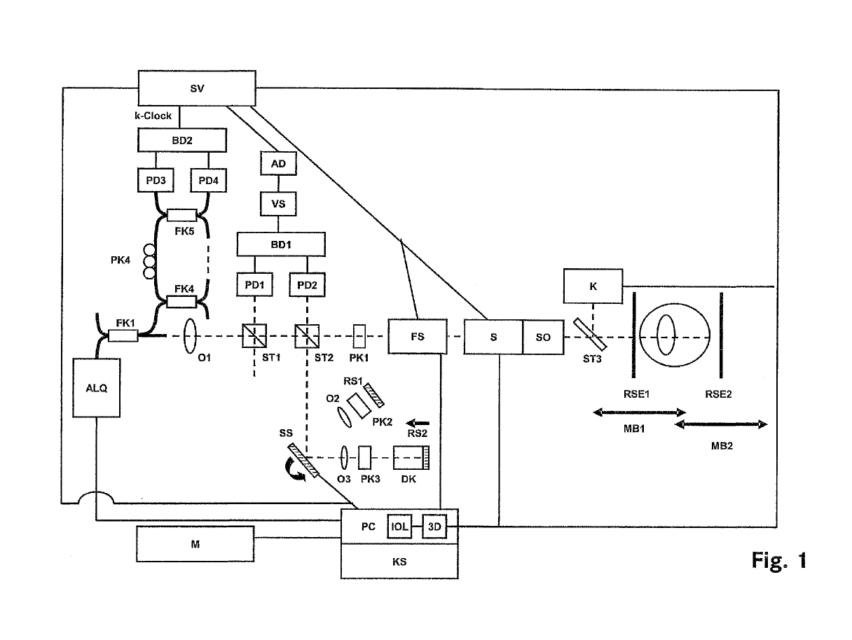

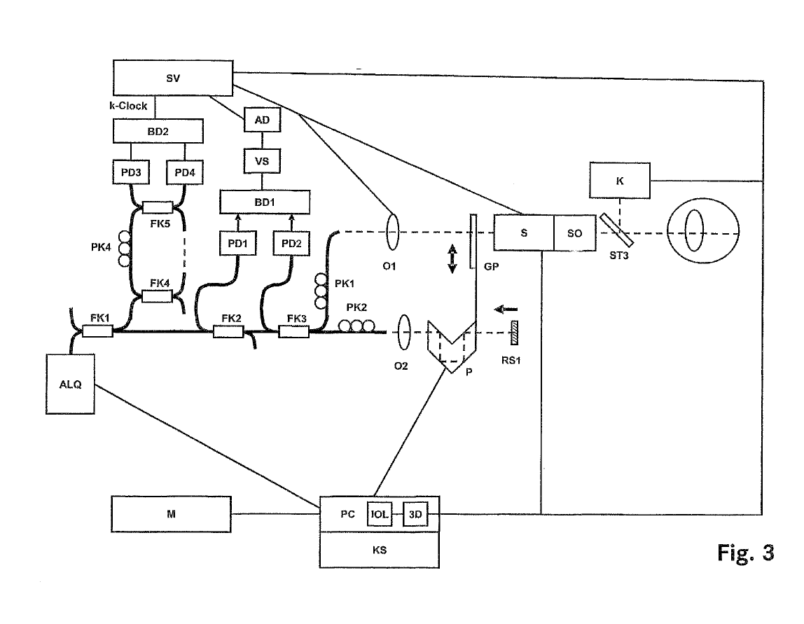

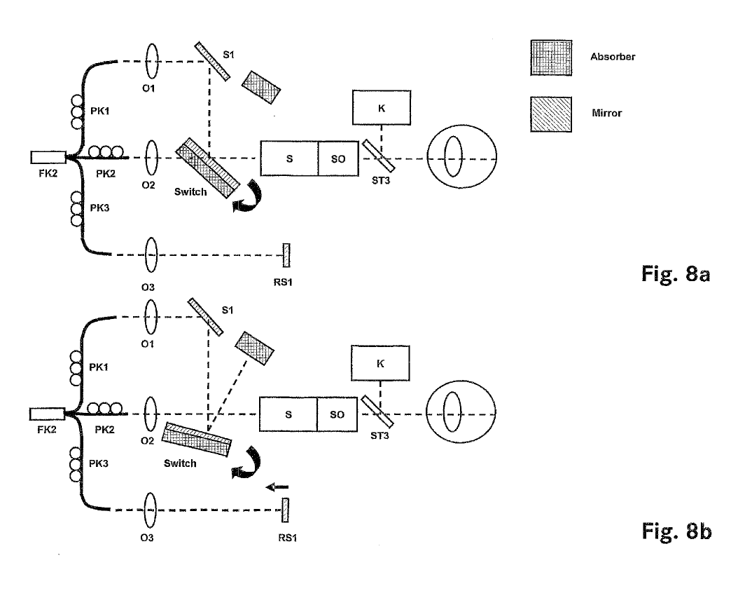

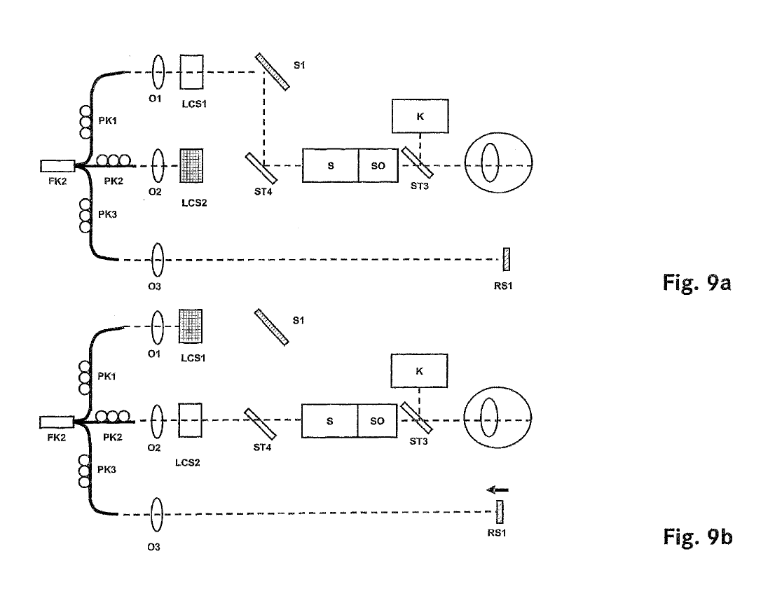

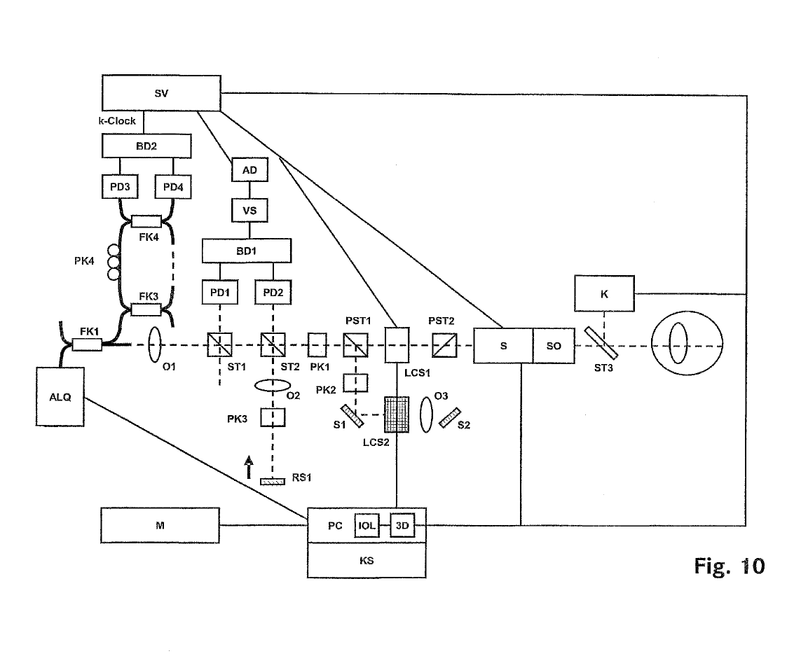

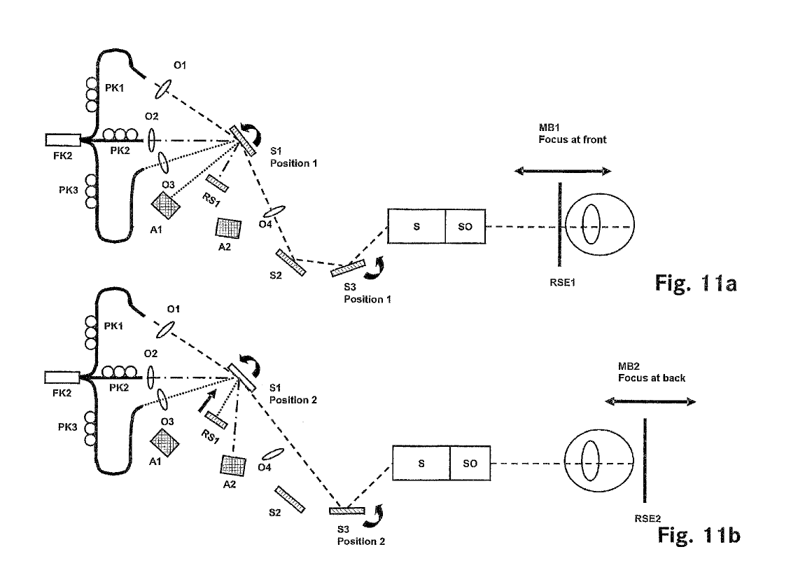

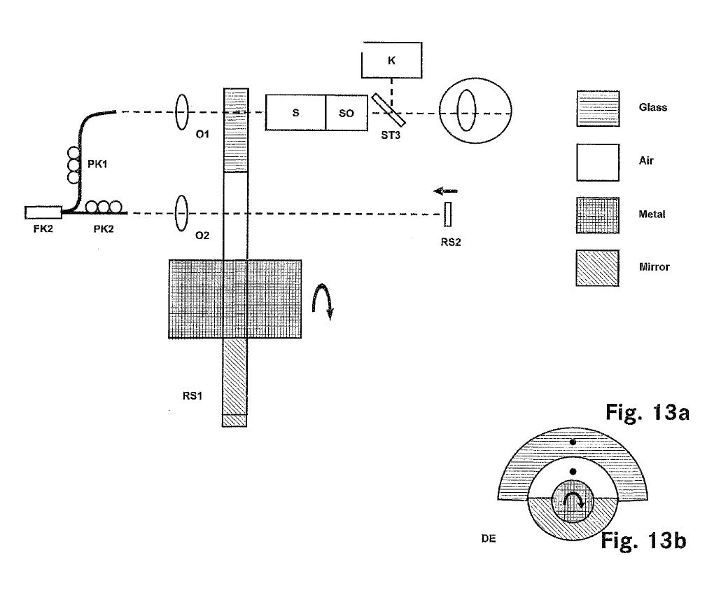

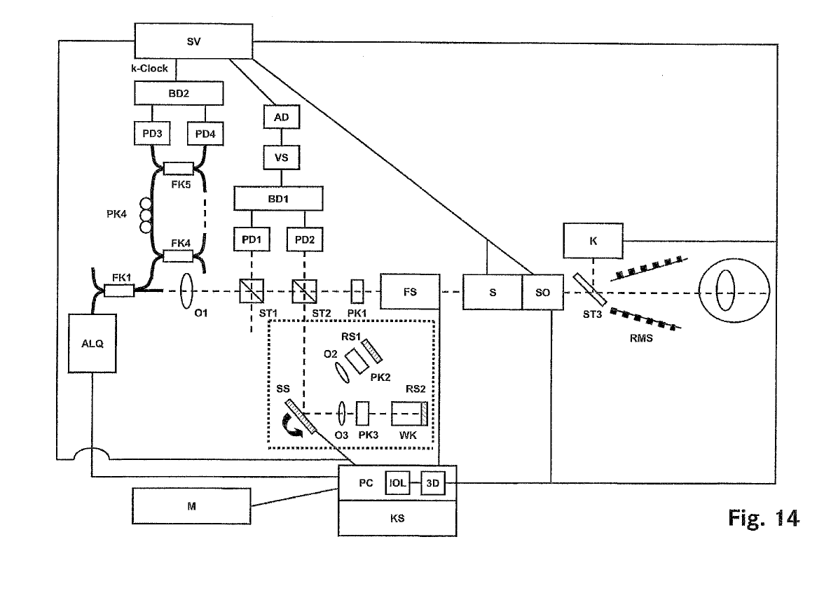

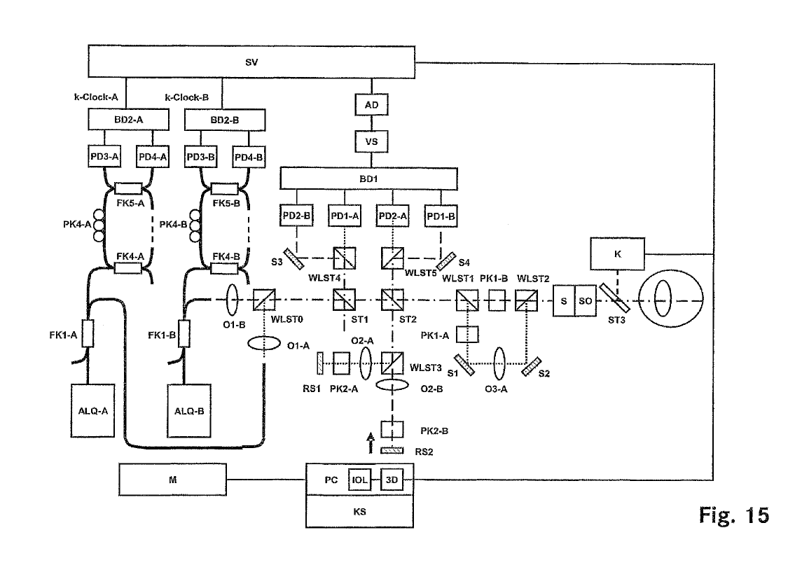

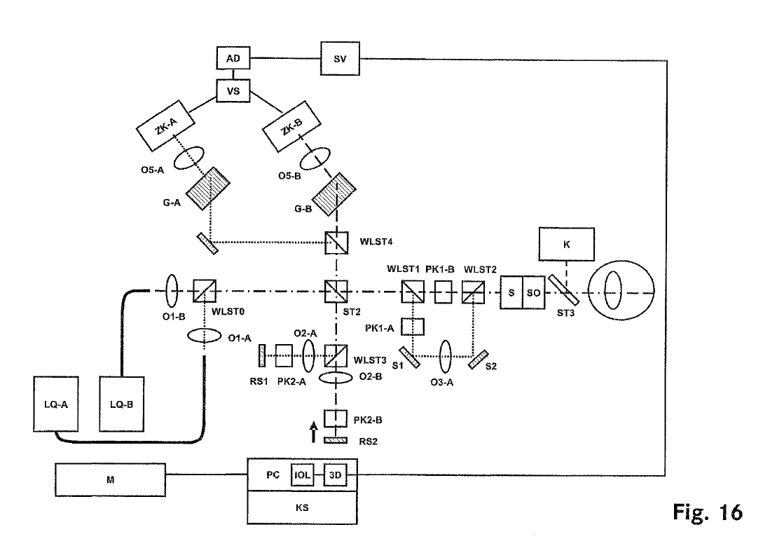

As mentioned above, the two depth scan regions can, in principle, be generated in five different ways, which are for the purpose of a better overview firstly briefly explained on the basis of the functional principles and with reference to the figures.
1. The light from the light source alternately propagates in two object arms of different length (see FIGS. 8a, 8b, 9a, 9b, 19a, 19b, 19c, 20, 21a, 21b, 22a, 22b, 22c), with use being made of one reference arm. The difference in the optical length of the two object arms corresponds to the optical distance between the two regions that are distanced from one another.
2. The light from the light source alternately propagates in two references arms of different length (see FIGS. 1, 2, 4, 5, 6, 7, 12a, 12b, 14), with use being made of one object arm. The difference in the optical length of the two reference arms corresponds to the optical distance between the two regions that are distanced from one another.
3. The light from the light source alternately propagates in two reference arms and in two object arms (see FIGS. 11a, 11b), with respectively one reference arm and one object arm always being used as a pair.
4. The light from the light source is conducted into a single arm, which successively in time has two different path lengths (see FIGS. 3, 13a, 13b). FIGS. 3, 13a, and 13b show a reference arm, which successively in time has path lengths of different length. An object arm that successively in time has path lengths of different length is also feasible. The optical change in the arm length corresponds to the optical distance between the two regions that are distanced from one another.
5. The light from the light source is simultaneously conducted into two arms of different length (see FIG. 9), with the light in the one arm differing from the light in the other arm in a specific property, e.g. in the polarization (see FIG. 10) or in the wavelength (see FIGS. 15, 16). In this case, a suitable separation apparatus must ensure that the light with a different property passes over paths of different length in the reference or object arm. Moreover, a suitable separation apparatus in the detection arm must be used to ensure that the two interferences are routed to different detectors.

A decision cannot be made, on the basis of the Fourier transform of the measured signals to be carried out, for purely mathematical reasons as to whether the optical distance of the reflection in the object is distanced from the optical distance of the reference mirror by a value of z or −z, and so the measured signals are arranged mirror-symmetrically around the point of the reference mirror. Thus, after the Fourier transform, there is one half of signals that appear at the correct position z (so-called “real signals”) and another half that appear at a wrong position −z. The signals that appear at the wrong point −z (so-called “mirror signals”) can only be identified and eliminated either if the optical distance of the reference arm is shorter than the optical distance of the closest object structure or if the optical distance of the reference arm is longer than the optical distance of the object structure furthest away. Thus, when measuring an object such as e.g. the entire eye there are two optimum points for the reference mirror. The one point thus corresponds to precisely the optical distance to the anterior side of the cornea and the other point corresponds to precisely the optical distance to the retina. So that the optical distance of the reference mirror at all axis lengths corresponds to at least the optical distance of the retina, it must lie at the optical distance of the retina of the longest eyes (34 mm) to be measured.

In FIG. 1, these facts are visualized using two vertical lines. The line of the reference mirror plane 1 RSE1 shows the position of the object arm at which the optical distance of the short reference arm is located. The line of the reference mirror plane 2 RSE2 shows the position of the object arm at which the optical distance of the long reference arm is located. MB1 lies in the anterior eye segment. MB1 is the measurement region (scan depth) that is provided by the short reference arm. All objects and eye structures that extend between the anterior corneal surface and the posterior lens surface are measured in MB1; in most cases this is the anterior corneal surface, the posterior corneal surface, the anterior lens surface, and the posterior lens surface. However, it may also be a flap-cut within the cornea or may be the sclera or iris. MB2 lies in the posterior eye segment. MB2 is the measurement region (scan depth) that is provided by the long reference arm. All objects and eye structures that are situated behind the posterior lens surface are measured in MB2; in most cases this is the retina. However, (abnormal) changes in the vitreous-humor structure may also be measured in the posterior measurement region.

Thus, the aforementioned deliberations show that the reference mirror plane must not lie e.g. within the cornea because otherwise it is not possible to determine with any certainty whether a real signal from the anterior side of the cornea or a mirror signal from the posterior side of the cornea or a real signal from the posterior side of the cornea or a mirror signal from the anterior side of the cornea is present. It is for the same reasons that the reference mirror plane may be situated neither within the aqueous humor nor within the lens nor within the vitreous humor.

Since the sensitivity of the measurement decreases with increasing distance of the signals from the reference mirror plane, and because the axis lengths to be measured cover a large range of typically 14-34 mm, the sensitivity of the retina signal can be greatly increased if the reference mirror in the position of the longest eyes to be measured is displaced step-by-step in the direction of the natural lens until the retina signal is at a maximum. It is for this reason that the reference arm that is responsible for measuring the retina has a displacement mechanism that displaces the reference mirror in the direction of the incident reference beam.

There are mathematical algorithms that permit attenuation of the mirror terms by a factor of approximately 1000. As a result, it becomes possible to subdivide the measurement object into more than 2 measurement regions, with the risk of erroneous measurements being greatly reduced as a result of the small amplitude of the mirror terms. By way of example, if use is made of 4 measurement regions, 4 reference arms must be activated in succession. This eases the requirements in respect of the coherence of the tunable light source. However, these mathematical algorithms are not always feasible in the case of fast moving objects such as e.g. the eye.

The individual figures are now described in detail in the following paragraphs:

### EMBODIMENT VARIANT 1

A first embodiment variant of the invention can be seen in FIG. 1. Light beams are illustrated as dashed lines, electrical lines are illustrated as continuous lines and optical fibers are illustrated as thick, continuous lines. A tunable light source ALQ emits a narrow spectral line (laser line). The light is routed to the reference arms and the object arm via a 2×2 fiber-optic coupler FK1, and two beam splitters ST1 and ST2. In the object arm, the light from the tunable light source reaches the measurement object, in this case the human eye, via a polarization controller PK1, via a focus switch FS, a scanner S, a scanning optical system SO, and a third beam splitter ST3. The beam splitter ST3 is a wavelength-selective beam splitter, which reflects the visible light to the camera K and transmits infrared light, which is usually used for the OCT light sources. The scanner deflects the light beam in one or two lateral dimensions over the cornea, from where the light beam is refracted into the eye. Every time the refractive index in the eye changes, some of the light is reflected. The reflected light returns along the same path to the beam splitter ST2. A camera K records a 2-dimensional image of the anterior part of the eye, which image is provided for the user on a monitor M. The camera image displayed on the monitor allows the user to position the measurement instrument in front of the eye of the patient with the aid of the cross slide KS such that the measurement is centered on the eye.

In the reference arm, the light reaches a glass substrate DK, the rear side of which is coated with a reference mirror RS2, via a scanner mirror SS and a focusing optical system O3. The glass substrate DK serves as a dispersion compensator for the signals reflected at the retina of the measurement object. The dispersion generated in the eye can be partly compensated for by a suitable glass substrate DK inserted into the reference arm and this increases the interference signal from the retina. The light reflected by this reference mirror RS1 returns along the same path to the beam splitter ST2. The arrow over the reference mirror RS2 should indicate that the initial position of the long reference arm corresponds to the reference mirror plane RSE2, which is situated directly behind the longest axis length to be measured of the eye. By advancing the reference mirror RS2 the signal from the retina is maximized when the optical path in the long reference arm, measured from the beam splitter ST2 to the reference mirror RS2, precisely corresponds to the optical path in the object arm, measured from the beam splitter ST2 to the retina.

In the position of the scanner mirror SS shown in FIG. 1 the light is conducted into the long reference arm, which leads to a measurement of the posterior eye segment (vitreous humor and the retina). The scanner mirror SS alternately adopts two positions. In the one position, the reference beam is deflected perpendicularly onto the reference mirror RS2 (see FIG. 1), in the other position it is deflected perpendicularly onto the reference mirror RS1.

If the reference beam is focused onto the reference mirror RS1 via the optical system O2, the eye is measured from the anterior side of the cornea to the posterior side of the lens. The amplitude of the interference signals can be maximized with the aid of the polarization controllers PK1, PK2, and PK3, consisting of the following components placed one behind the other: quarter-wave plate, half-wave plate, and quarter-wave plate.

In the beam splitter ST2 there is interference between the light reflected by the measurement object and the light reflected by the reference mirror. At the beam splitter ST2, the light is split into one part, which goes to the photodiode 1 PD1, and another part, which reaches the photodiode 2 PD2 via the beam splitter ST1. The interference signals from the photodiode 1 PD1 and PD2 have a phase difference of 180°. This phase difference, in combination with the two oppositely switched photodiodes 1 PD1 and 2 PD2 of a so-called balanced detection BD1, allows the suppression of the DC component of the incoherently superposed optical signals without adversely affecting the interference signal.

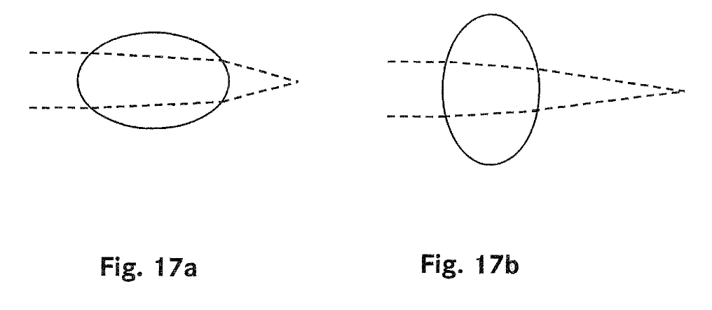

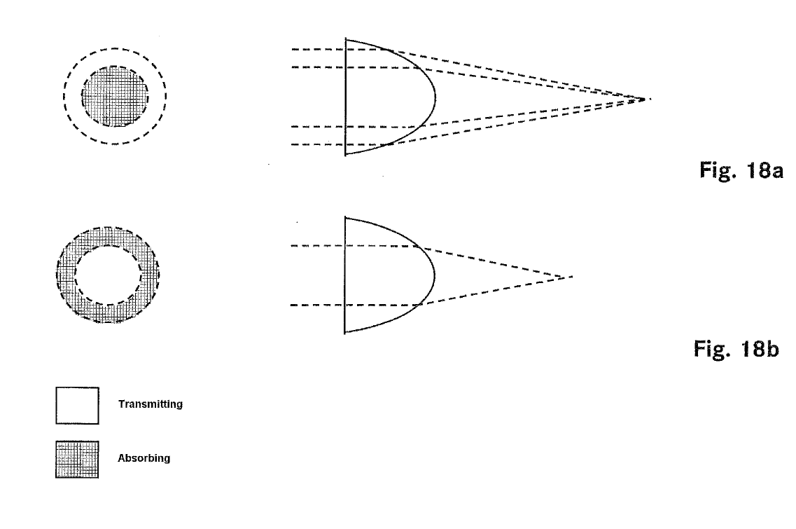

The focus switch FS switches the focus of the measurement beam between two or more axial positions in the eye. Preferably, respectively one focal position is adopted in the anterior measurement region MB1 and in the posterior measurement region MB2. The switching of the focal position must be synchronized with the switching of the scanner mirror SS. Possible embodiments of a focus switch are liquid lenses, which change the shape of their surface, or liquid crystals, which change their refractive index, or lenses, the position of which in the propagation direction of the light is adjusted e.g. by means of a piezo-actuator, or optical components, which are alternately pivoted into and out of the beam path of the object beam. A further option for changing the focal length lies in the use of a lens that has a focal length 1 (see FIG. 17a) when the light beam passes through it in the position 1, and has a focal length 2—for the same light beam (see FIG. 17b)—that differs from the focal length 1 when the lens is rotated by e.g. 90° into a position 2. In this case, the rotational axis of the lens is perpendicular to the propagation direction of the light that is focused by the lens. A beam modulator is feasible as an additional embodiment variant of a focus switch, which beam modulator restricts the beam cross section of a light beam alternately to an inner central disk or an outer annular region. The central or the annular beam bundle is incident on a lens that has two different focal lengths, in a central region and in an outer annular region. As a result, the central and the annular beam bundle are refracted by two different lens regions with different focal lengths. As a result there are two differently positioned foci in the propagation direction of the light (see FIGS. 18a, 18b). By way of example, the modulator can be e.g. a liquid crystal that, at a specific time, sets the outer annular region to transmit light and sets the central disk to absorb light and, at a later time, sets the outer annular region to absorb light and sets the central disk to transmit light.

The wavelength of the light as a function of time can be measured e.g. in a Mach-Zehnder interferometer and entered into the signal-processing stage SV as an electronic signal (so-called k-clock). The Mach-Zehnder interferometer consists of two 2×2 fiber-optic couplers FK4 and FK5. The signals from the Mach-Zehnder interferometer are rid of their DC component in the oppositely switched photodiodes PD3 and PD4 and the balanced detection BD2. The output of the balanced detection BD2 is the k-clock. The amplitude of the interference signals routed to the two photodiodes PD3 and PD4 is maximized with the aid of the polarization controller PK4.

After the balanced detection BD1, the signal is fed to an amplifier stage VS before it is digitized in an analog/digital converter AD. In the next stage—the digital signal processing SV—the temporal beat signals are, on the basis of the measured light wavelength, linearized as a function of time and Fourier transformed for each individual position of the scanner S and the mirror scanner SS. These individual A-scans can be averaged, smoothed, etc. in further processing steps. The A-scans, which are generated at each position of the scanner S and the mirror scanner SS, must be correctly placed next to one another in space. Thus, a set of A-scans is generated in 2- or 3-dimensional space, depending on whether the scanner S scans in one or two transverse directions.

In the next stage of the 3D-evaluation 3D, the surfaces of the cornea, the lens, and the retina are calculated (segmented) in this set of A-scans. The surfaces following the anterior corneal surface (posterior side of the cornea, anterior side of the lens, posterior side of the lens, and retina) are calculated thereafter by newly calculating the directions of the A-scans on the basis of the surface curvatures and refractive indices of the upstream surfaces. In this new calculation, the refraction of the light beams at the individual surfaces is taken into account (so-called refraction correction). Moreover, it is also possible to take into account the diffraction of the light beams at the pupil, which is particularly expedient in the case of pupils with a diameter of less than 3 mm. The surfaces obtained thereby may now be processed further, for example by being expanded according to a set of orthonormal functions (e.g. Zernike polynomials).

In the calculation block IOL, the surfaces of the anterior side of the cornea, posterior side of the cornea, anterior side of the lens and posterior side of the lens, and retina, which are spanned in 3-dimensional space, are irradiated by virtual light beams that follow the laws of refraction and diffraction. This so-called ray-tracing at the virtual surfaces of the human eye now allows the calculation of an intraocular lens, a photorefractive correction of the cornea, etc. by minimizing or optimizing the spatial extent of the beam pattern imaged on the retina.

The 3D-evaluation 3D and the calculation block IOL is usually carried out on a personal computer PC.

### EMBODIMENT VARIANT 2

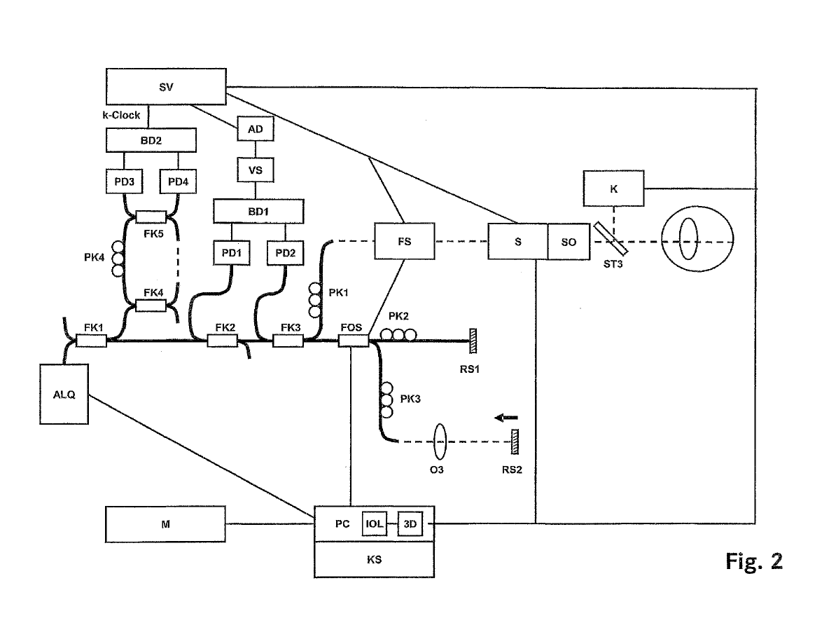

A second embodiment variant of the invention is drawn in FIG. 2. A tunable light source ALQ emits a narrow spectral line (laser line). The light is routed to the reference arms and the object arm via three 2×2 fiber-optic couplers FK1, FK2, and FK3. In the object arm, the light from the tunable light source ALQ reaches the measurement object, in this case the human eye, via a fiber-optic polarization controller PK1, via a focus switch FS, a scanner S, a scanning optical system SO, and a beam splitter ST3. The scanner S deflects the light beam in one or two lateral dimensions over the cornea, from where the light beam is refracted into the eye. Every time the refractive index in the eye changes, some of the light is reflected. The reflected light returns along the same path to the fiber-optic coupler FK3. A camera K records a 2-dimensional image of the anterior part of the eye, which is provided for the user on a monitor M. The camera image displayed on the monitor allows the user to position the measurement instrument in front of the eye of the patient with the aid of the cross slide KS such that the measurement is centered on the eye.

One output of the fiber-optic coupler FK3 leads to a fiber-optic switch FOS, which alternately routes the light to a long and a short reference arm. The short reference arm consisting of the fiber-optic polarization controller PK2 and a reference mirror RS1, which is applied directly on the end face of the optical fiber, allows interference between the radiation reflected in the short reference arm and the radiation reflected in the anterior eye segment. The long reference arm consisting of the fiber-optic polarization controller PK3, an optical system O3 and a reference mirror RS2 allows interference between the radiation reflected in the long reference arm and the radiation reflected in the posterior eye segment. The optical system O3 focuses the reference beam onto the reference mirror RS2. The remaining components in FIG. 2 are identical to those in FIG. 1 and are explained in the description of FIG. 1.

### EMBODIMENT VARIANT 3

FIG. 3 shows an embodiment variant of a mechanically synchronized focus and distance switching. An optical component consisting of a type of prism P is connected to a glass plate GP. By pivoting this component into and out of the beam path of the object and reference arm, the focus and the measurement region are synchronously switched to and fro between the anterior eye segment and the posterior eye segment. The reference mirror RS1 is moved to the position of the strongest retina signal when the prism P has been introduced into the reference beam. In this case the reference arm is long and the posterior eye segment is measured. If the prism P is not situated in the beam path of the reference arm, it is the anterior eye segment that is measured. In this position it is generally not necessary to move the reference mirror in order to optimize the signals from the anterior eye segment. The remaining components of this embodiment variant are described in FIG. 2.

### EMBODIMENT VARIANT 4

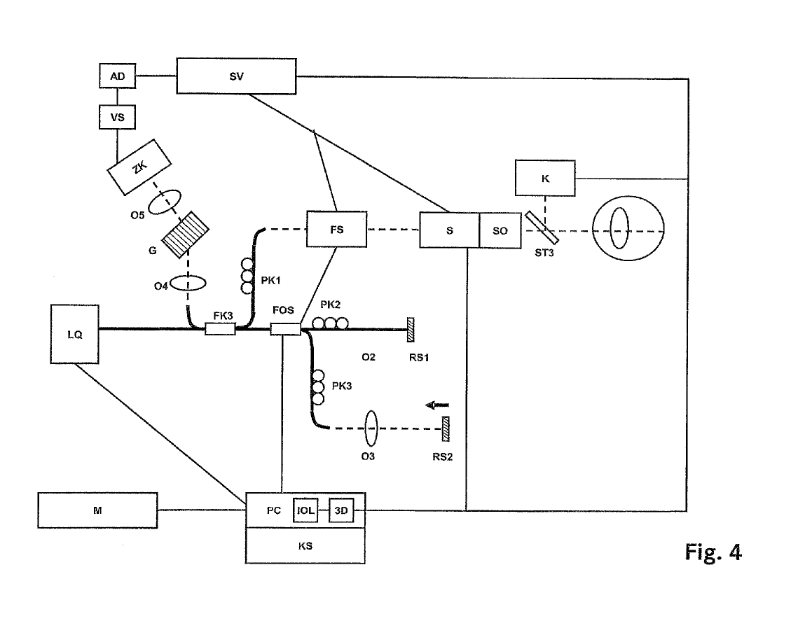

A further, fourth embodiment variant of the invention is illustrated in FIG. 4. FIG. 4 shows a measurement instrument based on spectral OCT. In contrast to the design illustrated in FIG. 2, the light source LQ is not tunable. The light source LQ emits a spectrum that is constant in time. Since the spectrum is unchanging, this embodiment does not require a k-clock; thus, in particular, the Mach-Zehnder interferometer, the fiber-optic coupler FK1, and the balanced detection BD2 with fiber-optic coupler FK2 that are all present in FIG. 2 are unnecessary and it is for this reason that they are not present in FIG. 4. Except for the source arm, the only difference to the embodiment that is shown in FIG. 2 lies in the detection of the interference signals. The light interference is brought onto a grating G in the detector arm via an optical system O4. The grating deflects the various wavelengths of the spectrum in different directions. This means that each pixel of the line-scan camera ZK detects a specific section from the wavelength spectrum of the light source LQ. The optical system O5 focuses the different wavelengths of the spectrum of the light source LQ onto the line-scan camera ZK. All remaining components in FIG. 4 are identical to those in FIG. 2 and are explained in the description of FIG. 2.

### EMBODIMENT VARIANT 5

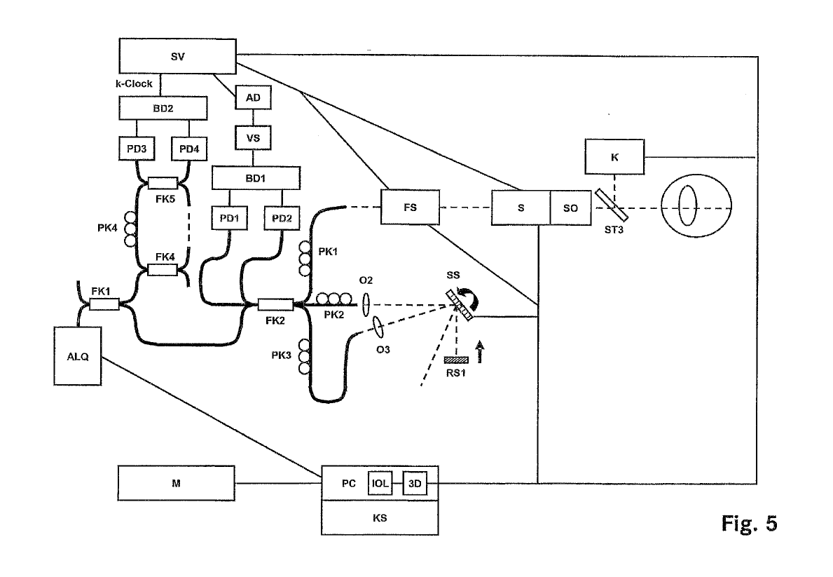

FIG. 5 shows an OCT with a tunable light source ALQ. In place of the two 2×2 fiber-optic couplers FK2 and FK3, as illustrated in FIG. 2, use is now made of a 3×3 fiber-optic coupler FK2. The 3×3 fiber-optic coupler FK2 divides the light into an object arm and two reference arms. The mirror scanner alternately deflects the light from the short reference arm and that from the long reference arm onto the reference mirror RS1. The polarization controllers PK1, PK2, and PK3 are used to match the polarization in the short reference arm or in the long reference arm to the polarization in the object arm. The optical system O2 focuses the light from the short reference arm onto the reference mirror RS1. The optical system O3 focuses the light from the long reference arm onto the reference mirror RS1. The remaining components have already been explained in the description of FIG. 2 and FIG. 1.

### EMBODIMENT VARIANT 6

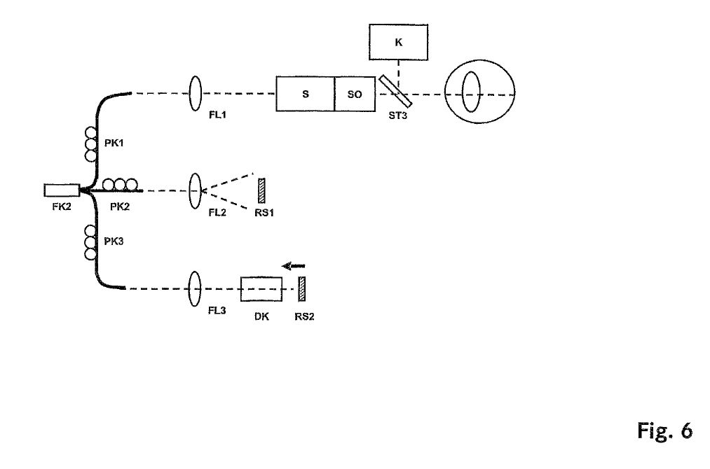

For reasons of simplicity, FIG. 6 only shows the two reference arms and the object arm of the OCT. The remaining components have been omitted. The source arm omitted in FIG. 6 can for example be identical to the source arm illustrated in FIG. 5. The detection arm omitted in FIG. 6 can for example be identical to the detection arm illustrated in FIG. 5. FIG. 6 shows three liquid lenses FL1, FL2, and FL3, which change their refractive indices periodically and in a synchronized fashion. FL2 focuses and defocuses the beam of the short reference arm onto the reference mirror RS1 at a certain rate, FL3 focuses and defocuses the beam of the long reference arm onto the reference mirror RS2 at the same rate, but the phase thereof has been shifted by 180°. As a result, only one of the two reference arms is capable at any one time of interference with the light reflected from the object arm. FIG. 6 shows how the liquid lens FL3 focuses the beam of the long reference arm, which contains the dispersion compensator DK, onto the reference mirror RS1. As a result, a very large proportion of the light power of the long reference arm is coupled back into the optical fiber of the fiber-optic coupler FK2. Thus it is the long reference arm that is capable of interference at the snapshot shown in FIG. 6. That is to say signals from the posterior eye segment are measured. Thus, one can say that the long reference arm is opened in the shown snapshot.

FIG. 6 shows how the liquid lens FL2 defocuses the reference beam. As a result, no proportion of the reference beam light power (or only a negligibly small amount thereof) returns into the optical fiber of the fiber-optic coupler FK2. Hence the short reference arm is not capable of interference with the light reflected from the object arm; that is to say that at this moment it is not possible to measure signals from the anterior eye segment. Thus, one can say that the short reference arm is closed.

The polarization controllers PK1, PK2, and PK3 are used to match the polarization in the short reference arm or in the long reference arm to the polarization in the object arm.

The liquid lens FL1 alternately focuses the measurement radiation into the anterior and posterior eye segment. The three liquid lenses FL1, FL2, and FL3 operate synchronously, that is to say if FL1 focuses the beam into the anterior eye segment, FL2 focuses the reference beam onto the reference mirror RS1 and FL3 defocuses the reference beam on the reference mirror RS2. If FL1 focuses the beam into the posterior eye segment, FL2 defocuses the reference beam on the reference mirror RS1 and FL3 focuses the reference beam onto the reference mirror RS2.

### EMBODIMENT VARIANT 7

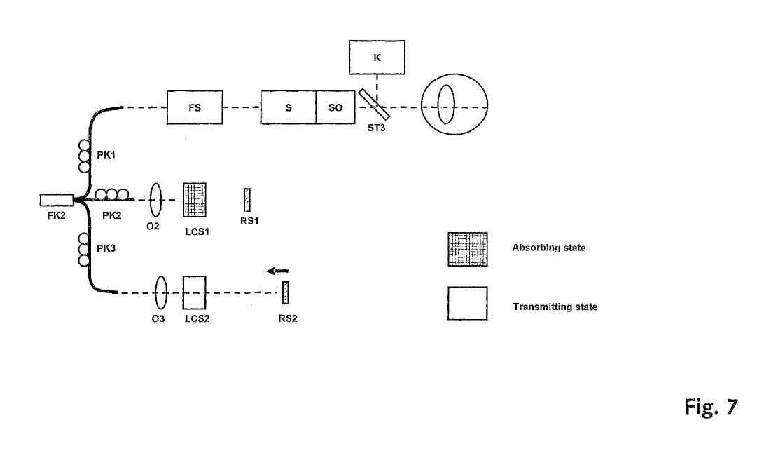

For reasons of simplicity, FIG. 7 only shows the two reference arms and the object arm of the OCT. The remaining components have been omitted. The source arm omitted in FIG. 7 can for example be identical to the source arm illustrated in FIG. 5. The detection arm omitted in FIG. 7 can for example be identical to the detection arm illustrated in FIG. 5. The opening and closing of the two reference arms is brought about using two liquid crystals LCS1 and LCS2. LCS1 opens and closes the short reference arm; LCS2 opens and closes the long reference arm. At any one time, only one of the two liquid crystals is in a transmitting state, and so only one of the two reference arms is at any one time capable of interference with the radiation reflected from the object arm. No dispersion compensator has been sketched in FIG. 7. Up to a certain degree, the optical fiber in the long reference arm can also be used as a dispersion compensator by compensating for the path in the posterior eye segment by a corresponding path in the optical fiber.

The polarization controller PK1, PK2, and PK3 are used to match the polarization in the short reference arm or in the long reference arm to the polarization in the object arm. The optical system O2 focuses the light from the short reference arm onto the reference mirror RS1. The optical system O3 focuses the light from the long reference arm onto the reference mirror RS2.

### EMBODIMENT VARIANT 8

Embodiment variant 8 shows a design with one reference arm and two object arms. For reasons of simplicity, FIGS. 8a and 8b do not show the source arm and the detection arm. The source arm omitted in FIGS. 8a and 8b can for example be identical to the source arm illustrated in FIG. 5. The detection arm omitted in FIGS. 8a and 8b can for example be identical to the detection arm illustrated in FIG. 5. A switch alternately opens and closes one of the two object arms. At any one time, only one of the two object arms is opened, and so at any one time only one of the two object arms is capable of interference with the radiation reflected from the reference arm. If the upper of the two object arms is opened (as illustrated in FIG. 8a), the light reflected in the anterior eye segment is capable of interference with the light reflected from the reference arm. The difference in the optical path length between the path from FK2 to the switch via S1 (long object arm) and the path from FK2 via O2 and the switch (short object arm) corresponds to the optical length of the anterior eye segment. FIG. 8a shows that the light from the short object arm is absorbed at the switch. The switch can be e.g. a mirror, which alternately adopts two different angular positions. If the mirror folds downward then the short object arm is opened, see FIG. 8b. In this position of the mirror, the light from the long object arm is absorbed in the absorber A1.

The reference mirror RS1 is only displaced when the short object arm is opened. The displacement of the reference mirror starts from a position that is used for measuring the longest eyes to be measured. By displacing the reference mirror in the direction of the optical system O3, that position of the reference mirror is adopted at which the retina signal is at a maximum. Maximizing the retina signal is required in those eyes in which the retina signal is strongly attenuated as the result of a cataract being present.

The polarization controllers PK1, PK2, and PK3 are used to match the polarization in the short object arm or in the long object arm to the polarization in the reference arm. The optical system O1 focuses the light from the long object arm into the anterior eye segment. The optical system O2 focuses the light from the short object arm into the posterior eye segment. The optical system O3 focuses the light from the reference arm onto the reference mirror RS1.

### EMBODIMENT VARIANT 9

Embodiment variant 9 shows a design with one reference arm and two object arms. For reasons of simplicity, FIGS. 9a and 9b do not show the source arm and the detection arm. The source arm omitted in FIGS. 9a and 9b can for example be identical to the source arm illustrated in FIG. 5. The detection arm omitted in FIGS. 9a and 9b can for example be identical to the detection arm illustrated in FIG. 5. Two switches in the form of two liquid crystals LCS1 and LCS2 alternately open and close one of the two object arms. At any one time, only one of the two object arms is opened, and so at any one time only one of the two object arms is capable of interference with the radiation reflected from the reference arm. If the upper of the two object arms is opened (as illustrated in FIG. 9a), the light reflected in the anterior eye segment is capable of interference with the light reflected from the reference arm. The difference in the optical path length between the path from FK2 to the beam splitter ST4 via S1 (long object arm) and the path from FK2 via O2 and the beam splitter ST4 (short object arm) corresponds to the optical length of the anterior eye segment. FIG. 9a shows that the light from the short object arm is absorbed in the liquid crystal LCS2. FIG. 9b shows a snapshot during which the light from the short object arm is routed to the eye. In this setting, the light from the short reference arm is capable of interference with the light reflected from the object arm.

FIG. 9b shows that the light from the long object arm is absorbed in the liquid crystal LCS1.

The reference mirror RS1 is only displaced when the short object arm is opened. The displacement of the reference mirror starts from a position that is used for measuring the longest eyes to be measured. By displacing the reference mirror in the direction of the optical system O3, that position of the reference mirror is adopted at which the retina signal is at a maximum. Maximizing the retina signal is required in those eyes in which the retina signal is strongly attenuated as the result of a cataract being present.

The polarization controllers PK1, PK2, and PK3 are used to match the polarization in the short object arm or in the long object arm to the polarization in the reference arm. The optical system O1 focuses the light from the long object arm into the anterior eye segment. The optical system O2 focuses the light from the short object arm into the posterior eye segment. The optical system O3 focuses the light from the reference arm onto the reference mirror RS1.

### EMBODIMENT VARIANT 10

FIG. 10 shows a design with two polarizing beam splitter cubes PST1 and PST2 and two liquid crystals LCS1 and LCS2. There are two object arms and one reference arm in FIG. 10. From the light source ALQ to the beam splitter ST2, the embodiment variant shown in FIG. 10 corresponds to the embodiment variant shown in FIG. 1. The optical system O2 focuses the reference beam onto the reference mirror RS1. There are two object arms, wherein one of the two object arms contains a detour unit. The detour unit consists of a polarization controller PK2, two deflection mirrors S1 and S2, a liquid crystal LCS2, and an optical system O3. The optical system O3 focuses the measurement beam into the anterior eye segment. The polarization controllers PK1, PK2, and PK3 are used to match the polarization in the reference arm to the polarization in the object arm with the detour unit or the object arm without the detour unit. The polarizing beam splitter cube PST1 splits the incident measurement beam into one beam with mutually perpendicular polarizations. That is to say the polarization of the radiation that passes through the detour unit is perpendicular to the polarization of the radiation that does not pass through the detour unit. The polarizing beam splitter cube PST2 recombines the two mutually perpendicular polarizations. Since the eye is only weakly birefringent, the two polarizations reflected by the eye structures will pass over the path that they passed over on the way out. That is to say if the incident p-polarization passes through the detour unit, the reflection of the p-polarization incident on the eye also passes through the detour unit; and if the incident s-polarization does not pass through the detour unit, nor does the reflection of the s-polarization incident on the eye pass through the detour unit. The light that passes through the detour unit measures the anterior eye segment. The light that does not pass through the detour unit measures the posterior eye segment. In the snapshot shown in FIG. 10, the liquid crystal LCS1 opens the object arm without detour unit and the liquid crystal LCS2 closes the object arm with the detour unit.

### EMBODIMENT VARIANT 11

FIGS. 11a and 11b show a design in which a rotatable mirror S1 acts as both a distance and focus switch. This is made possible by the rotatable mirror S1 influencing both the two reference beams and the object beam.

For reasons of simplicity, FIGS. 11a and 11b do not show the source arm and the detection arm. The source arm omitted in FIGS. 11a and 11b can for example be identical to the source arm illustrated in FIG. 5. The detection arm omitted in FIGS. 11a and 11b can for example be identical to the detection arm illustrated in FIG. 5.

The optical system O1 deflects the object beam onto the mirror S1. The optical system O2 focuses the reference beam from the short reference arm onto the reference mirror RS1, see FIG. 11a. The optical system O3 focuses the reference beam from the long reference arm onto the reference mirror RS1, see FIG. 11b. The polarization controllers PK1, PK2, and PK3 are used to match the polarization in the reference arms to the polarization in the object arm.

In the position 1 of the mirror S1, the light in the short reference arm is reflected at the reference mirror RS1, and so interference is made possible between the light reflected from the short reference arm and the light reflected from the anterior measurement region of the object arm. In the position 1, the light in the long reference arm is not reflected, and so interference is not possible between the light reflected from the long reference arm and the light reflected from the posterior measurement region of the object arm. The light from the long reference arm is preferably absorbed at an absorber A1 so that no light from the long reference arm is coupled back into the fiber-optic coupler FK2. In the position 1 of the mirror S1, the light from the object arm is routed to the optical system O4, which, in combination with the scanning optical system SO, focuses the light in the anterior measurement region MB1. The measurement beam is deflected by the fixed mirror S2 onto the mirror S3, which is in position 1.

In the position 2 of the mirror S1, the light in the long reference arm is reflected at the reference mirror RS1, and so interference is made possible between the light reflected from the long reference arm and the light reflected from the posterior measurement region of the object arm. In the position 2, the light in the short reference arm is not reflected, and so interference is not possible between the light reflected from the short reference arm and the light reflected from the anterior measurement region of the object arm. The light from the short reference arm is preferably absorbed at an absorber A2 so that no light from the short reference arm is coupled back into the fiber-optic coupler FK2. In the position 2 of the mirror S1, the light from the object arm is directly routed to the mirror S3, which is now in the position 2. The position 2 of the mirror S3 deflects the measurement beam such that the propagation direction of the measurement beam after the reflection at the mirror S3 corresponds precisely to the propagation direction when the mirror S1 and the mirror S3 are in position 1. In the position 2 of the mirror S1, the measurement beam does not pass through the optical system O4 and is therefore focused in the posterior measurement region MB2.

### EMBODIMENT VARIANT 12

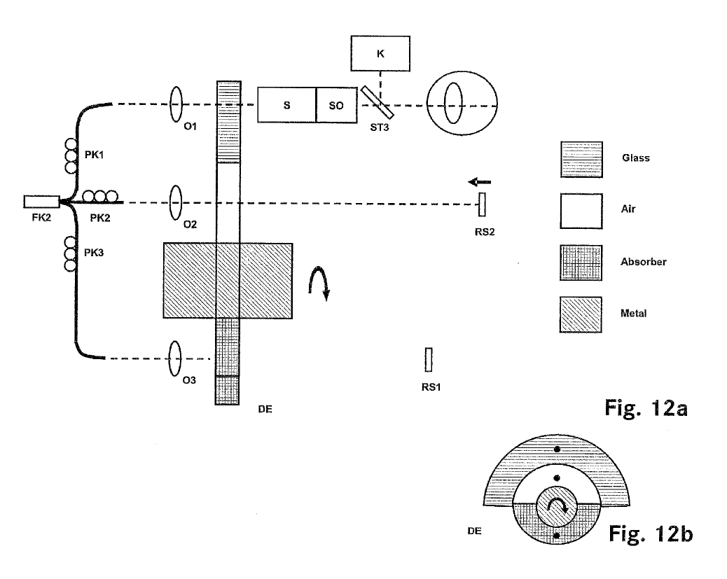

Embodiment variant 12 shows a design with two reference arms and one object arm. The embodiment variant shown in FIGS. 12a and 12b depicts a mechanically synchronized focus and distance switching.

For reasons of simplicity, FIG. 12a does not show the source arm and the detection arm. The source arm omitted in FIG. 12a can for example be identical to the source arm illustrated in FIG. 5. The detection arm omitted in FIG. 12a can for example be identical to the detection arm illustrated in FIG. 5. FIG. 12a shows a rotatable element DE, which consists of a rotational axis, a semicircular glass plate, a semicircular absorber, and a semicircular hole. The rotatable element DE alternately, in each case during half a revolution, activates a short and a long reference arm by either absorbing the respective reference beam by the absorbing material of the rotatable element DE or by transmitting said reference beam through the hole in the rotatable element DE. Moreover, the rotatable element DE inserts a glass plate into the beam path in the object arm during half a revolution. The thickness of the glass plate is selected such that the focus of the measurement beam comes to rest in the posterior eye segment when the measurement beam passes through the glass plate (see FIG. 12a). In this position of the rotatable element DE the long reference arm is opened and the beam from the short reference arm is absorbed. The posterior eye segment is measured in this position.

If the rotatable element is in the position in which the glass plate is not situated in the beam path of the measurement beam then the focus of the measurement beam is situated in the anterior eye segment. The focus of the measurement beam jumps from the anterior to the posterior eye segment at precisely that moment at which the short reference arm, which is used for measuring the anterior eye segment, is closed by the absorber and at which the long reference arm, which is used for measuring the posterior eye segment, is opened, so that it can propagate unhindered to the reference mirror RS2.

FIG. 12b shows the rotatable element DE from a perspective that is rotated by 90° compared to the perspective shown in FIG. 12a. The three black points show the penetration points of the object-arm beam and the two reference-arm beams.

### EMBODIMENT VARIANT 13

Embodiment variant 13 shows a design with one reference arm and one object arm.

For reasons of simplicity, FIG. 13a does not show the source arm and the detection arm. The source arm omitted in FIG. 13a can for example be identical to the source arm illustrated in FIG. 3. The detection arm omitted in FIG. 12a can for example be identical to the detection arm illustrated in FIG. 3. FIG. 13a shows a rotatable element DE, which consists of a rotational axis, a semicircular glass plate, a semicircular mirror, and a semicircular hole. The rotatable element DE alternately, in each case during half a revolution, activates a short and a long reference arm by either reflecting the respective reference beam at the mirror of the rotatable element DE or by transmitting said reference beam through the hole in the rotatable element DE. If the mirror of the rotatable element DE is in the beam path of the reference arm, the mirror of the rotatable element DE acts as reference mirror for the short reference arm.

Moreover, the rotatable element DE inserts a glass plate into the beam path in the object arm during half a revolution. The thickness of the glass plate is selected such that the focus of the measurement beam comes to rest in the posterior eye segment when the measurement beam passes through the glass plate. If the rotatable element is in the position in which the glass element is not situated in the beam path of the measurement beam then the focus of the measurement beam is situated in the anterior eye segment. Thus, the focus of the measurement beam jumps from the anterior to the posterior eye segment at precisely that moment at which the mirror in the rotatable element DE is rotated out of the reference arm so that the long reference arm, which is used for measuring the posterior eye segment, is opened, so that the reference beam can propagate unhindered to the reference mirror RS2.

FIG. 13b shows the rotatable element DE from a perspective that is rotated by 90° compared to the perspective shown in FIG. 13a. The two black points show the penetration points of the object arm and the reference arm.

### EMBODIMENT VARIANT 14

Embodiment variant 14 is identical to the embodiment variant 1 except for the one difference that a cone or hemisphere is attached directly in front of the eye of the patient, which cone or hemisphere has an interior pattern of concentric dark and light annuli. This annular pattern system RMS is mirrored by the tear film of the examined eye. The reflection of this annular pattern system is recorded by the camera K. Software can calculate the surface shape of the tear film or the anterior corneal surface from the deformation of the annular pattern system imaged on the camera. The surface shape measured by the annular pattern system is used to improve the measurement accuracy of the OCT measurement.

### EMBODIMENT VARIANT 15

Embodiment variant 15 is illustrated in FIG. 15. In this embodiment, the anterior eye segment and the posterior eye segment are measured at different wavelengths. The use of two wavelengths may be advantageous because the maximum permissible optical power that may be used to measure living human eyes increases with increasing wavelength. Hence a longer wavelength A (e.g. 1300 nm) with higher optical power may be used for measuring the anterior eye segment, where the penetration depth of the measurement radiation need not be as great as in the posterior eye segment, than for measuring the posterior eye segment (e.g. 850 nm or 1060 nm). In FIG. 15, the wavelength A is displayed as a dotted line while the other wavelength B is illustrated as a dashed line.

A tunable light source ALQ-A emits a narrow spectral line (laser line). The light is conducted into a reference arm and an object arm via a 2×2 fiber-optic coupler FK1-A, an optical system O1-A, a wavelength-selective beam splitter WLST0, and two beam splitters ST1 and ST2. The wavelength-selective beam splitter WLST0 is coated such that the wavelengths from the tunable light source ALQ-A are almost entirely reflected and the wavelengths from the tunable light source ALQ-B are almost entirely transmitted. As a result, the two wavelengths from the two tunable light sources are unified almost without losses. In the object arm, the light from the tunable light source ALQ-A reaches the measurement object, in this case the human eye, from a wavelength-selective beam splitter WLST1 via a polarization controller PK1-A, via a mirror S1, an optical system O3-A, a wavelength-selective beam splitter WLST2, a scanner S, a scanning optical system SO, and a third beam splitter ST3. The optical system O3-A, in combination with the scanning optical system SO, focuses the light from the light source ALQ-A into the anterior eye segment. The beam splitter ST3 is a wavelength-selective beam splitter, which reflects the visible light to the camera K and transmits infrared light that is usually used for the OCT light sources. The scanner deflects the light beam in one or two lateral dimensions over the cornea, from where the light beam is refracted into the eye. Every time the refractive index in the eye changes, some of the light is reflected. The reflected light returns along the same path to the beam splitter ST2. A camera K records a 2-dimensional image of the anterior part of the eye, which is provided for the user on a monitor M. The camera image displayed on the monitor allows the user to position the measurement instrument in front of the eye of the patient with the aid of the cross slide KS such that the measurement is centered on the eye.

In the reference arm, the light from the light source ALQ-A is deflected onto the reference mirror RS1 by the wavelength-selective beam splitter WLST3. The optical system O2-A focuses the reference beam onto the reference mirror RS1. The light reflected by this reference mirror RS1 returns along the same path to the beam splitter ST2. The length of the reference arm for the light source ALQ-A is designed such that this reference arm measures the anterior eye segment.

A second tunable light source ALQ-B emits a narrow spectral line (laser line). The light is conducted into a reference arm and an object arm via a 2×2 fiber-optic coupler FK1-A, a wavelength-selective beam splitter WLST0, and two beam splitters ST1 and ST2. The light from the tunable light source ALQ-B is, in the object arm, transmitted through a wavelength-selective beam splitter WLST1, from where it reaches the eye via a polarization controller PK1-B, via a wavelength-selective beam splitter WLST2, via a scanner S, a scanning optical system SO, and a beam splitter ST3. The scanning optical system SO focuses the light from the light source ALQ-B into the posterior eye segment.

The light from the light source ALQ-B is, in the reference arm, deflected onto the reference mirror RS2 by the wavelength-selective beam splitter WLST3. The optical system O2-B focuses the reference beam onto the reference mirror RS2. The light reflected by this reference mirror RS2 returns along the same path to the beam splitter ST2. The length of the reference arm for the light source ALQ-B is designed such that this reference arm measures the posterior eye segment. The arrow over the reference mirror RS2 is intended to indicate that the initial position of this reference arm corresponds to the reference mirror plane RSE2, which is situated directly behind the longest axis length to be measured of the eye. The signal from the retina is maximized by advancing the reference mirror RS2.

The amplitude of the interference signals can be maximized with the aid of the polarization controllers PK1-A, PK2-A, PK1-B, and PK2-B, consisting of the following components placed one behind the other: quarter-wave plate, half-wave plate, and quarter-wave plate.

In the beam splitter ST2 there is interference between the light reflected by the measurement object and by the reference mirror, wherein the light from the two light sources can only interfere with itself. At the beam splitter ST2, the light is split into one part, which goes to the wavelength-selective beam splitter WLST5, and into another part, which goes to the wavelength-selective beam splitter WLST4 via the beam splitter ST1. The two wavelength-selective beam splitters WLST4 and WLST5 separate the wavelengths from the two light sources and transmit the light to the various photodiodes PD1-A, PD2-A, PD1-B, and PD2-B. The interference signals from the photodiodes PD1-A and PD2-A have a phase difference of 180°. This phase difference, in combination with the two oppositely switched photodiodes PD1-A and PD2-A of a so-called balanced detection BD1, allows the suppression of the DC component of the incoherently superposed optical signals without adversely affecting the interference signal. The same holds true for the photodiodes that detect the light from the light source ALQ-B.

Both light sources each comprise a Mach-Zehnder interferometer, the output signals of which are measured by respectively two oppositely switched photodiodes PD3-A, PD4-A, or PD3-B, PD4-B, and respectively one balanced detection. BD2-A and BD2-B. Both Mach-Zehnder interferometers each consist of two 2×2 fiber-optic couplers FK4-A and FK5-A, or FK4-B and FK5-B. The output of the balanced detection BD2-A is the k-clock from the light source ALQ-A, called k-clock-A. The output of the balanced detection BD2-B is the k-clock from the light source ALQ-B, called k-clock-B. The amplitude of the interference signals routed to the two photodiodes PD3-A and PD4-A is maximized with the aid of the polarization controller PK4-A. The amplitude of the interference signals routed to the two photodiodes PD3-B and PD4-B is maximized with the aid of the polarization controller PK4-B.

The remaining components in FIG. 15 have already been explained in the description of FIG. 1.

### EMBODIMENT VARIANT 16

A further embodiment variant that makes use of two different wavelengths and two different light sources is sketched in FIG. 16. FIG. 16 shows a measurement instrument based on spectral OCT. In contrast to the design illustrated in FIG. 15, the light sources LQ-A and LQ-B are not tunable. The light sources LQ-A and LQ-B emit a spectrum that is constant in time. Since the spectrum is unchanging, this embodiment does not require a k-clock; thus, in particular, the Mach-Zehnder interferometers and the fiber-optic couplers FK1-A and FK1-B, present in FIG. 15, are unnecessary. Moreover, the balanced detection BD2-A, BD2-B is usually not present in spectral OCT and it is for this reason that it is not present in FIG. 16. Except for the source arm, the only difference to the embodiment that is shown in FIG. 15 lies in the detection of the interference signals. The interferences from the light source LQ-A and the light source LQ-B are separated by a wavelength-selective beam splitter WLST4 and are routed to two different gratings G-A, G-B. The gratings deflect the various wavelengths of the spectrum in different directions. This means that each pixel of the line-scan cameras ZK-A and ZK-B detects a specific section from the wavelength spectrum of the light source LQ-A or LQ-B. The optical systems O5-A and O5-B focus the different wavelengths of the spectrum from the light sources LQ-A or LQ-B onto the line-scan camera ZK-A or ZK-B. All remaining components in FIG. 16 are identical to those in FIG. 15 and are explained in the description of FIG. 15.

### EMBODIMENT VARIANT 17

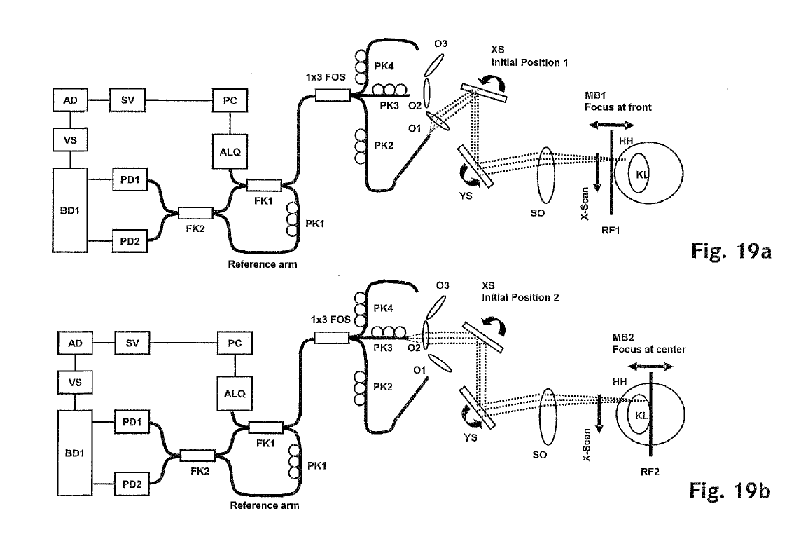

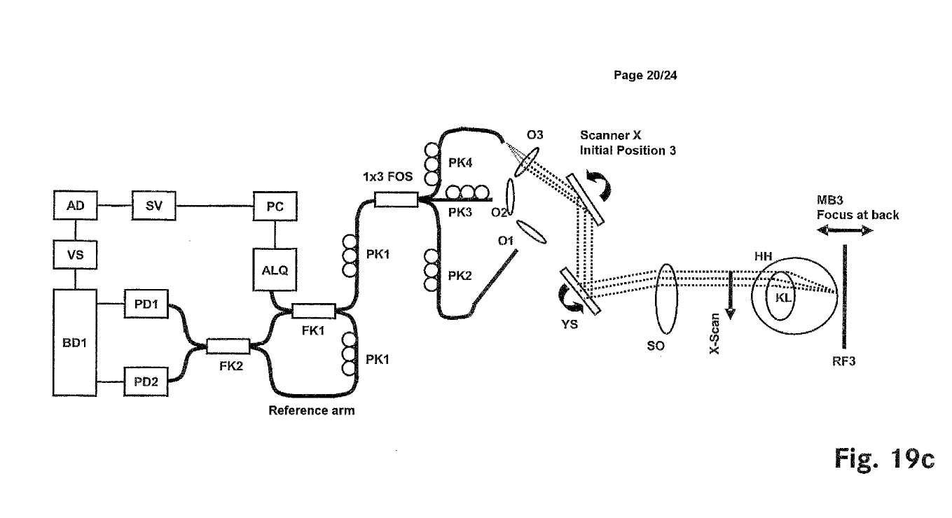

An embodiment variant that synchronously displaces the focus and the measurement distance is illustrated in FIGS. 19a, 19b, and 19c. The light from a tunable light source ALQ is conducted into a 2×2 fiber-optic coupler FK1. The fiber-optic coupler FK1 divides the light into three object arms and one reference arm. The reference arm consists of a mono-mode optical fiber and a polarization controller PK2. An example of a polarization controller is a device in which the mono-mode fiber is wound in three loops. Each of these three loops is mechanically tiltable and this allows any polarization state to be impressed onto the light in the mono-mode optical fiber. The reference arm starts at the fiber-optic coupler FK1 and ends at the fiber-optic coupler FK2. The optical length of the reference arm remains constant. The interference between the light from the reference arm and the light from the utilized object arm occurs in the fiber-optic coupler FK2.

Three object arms are produced by a fiber-optic 1×3 switch FOS. The fiber-optic switch FOS alternately routes the light into three different object arms. In each of the three object arms there respectively is one polarization controller PK2, PK3, and PK4 and respectively one optical system O1, O2, and O3. An X-scanner XS, a Y-scanner YS, and a scanning optical system SO are shared by all three object arms. The three object arms differ in terms of the refractive indices of the three optical systems O1, O2, and O3, and in terms of the optical length, which is measured from the fiber-optic 1×3 switch FOS to the anterior surface of the object. In FIGS. 19a, 19b, and 19c, the anterior surface of the object is the anterior corneal surface. The measurement beams are illustrated by three light beams in FIGS. 19a, 19b, and 19c for the purpose of better illustration of the foci.

In FIG. 19a, the 1×3 switch FOS routes the light to the object arm with the long optical fiber. If the light passes through this object arm then the light that is reflected in the anterior measurement region MB1 interferes with the light from the reference arm. The optical system O1, in combination with the scanning optical system SO, preferably focuses the light between the anterior corneal surface HH and the anterior surface of the crystalline lens KL. The anterior reference surface RF1 is that surface in the anterior measurement region MB1 that has the same optical length as the reference arm. This means that the measurement sensitivity of the anterior measurement region MB1 is at a maximum on this surface RF1. The X-scanner XS deflects the light from the object arm over the object in the X-direction. The movement direction of the measurement beam deflected by the X-scanner XS is indicated by the arrow of the X-scan. At the start of the X-scan, the X-scanner XS assumes the initial position 1, which leads to the scan in the X-direction starting at the edge of the cornea. The Y-scanner YS deflects the light from the object arm over the object in the Y-direction. A scanning optical system SO serves to deflect the measurement beams onto the eye such that they impinge on the anterior corneal surface at the desired angle. The scanning optical system will normally be selected such that the measurement beams are deflected telecentrically over the measurement object. The polarization controller PK2 is used to set the polarization of the beam reflected by the object such that the strongest possible interference signal is detected in the detection arm consisting of the photodiodes PD1 and PD2, a balanced detection BD1, an amplifier stage VS, an analog/digital converter AD, and signal-processing SV. The measurement signals are transmitted to a computer PC, which processes them further and provides them to the user as numerical values or as an image on a monitor.

In FIG. 19b the 1×3 switch FOS routes the light to the object arm with the medium-length optical fiber. For reasons of simplicity, the medium-length optical fiber is too short in the illustrations in FIGS. 19a, 19b, and 19c. If the light passes through this object arm then the light that is reflected in the central measurement region MB2 interferes with the light from the reference arm. The central reference surface RF2 is that surface in the central measurement region MB2 that has the same optical length as the reference arm. This means that the measurement sensitivity of the central measurement region MB2 is at a maximum on this surface RF2. The optical system O2, in combination with the scanning optical system SO, preferably focuses the light in the vicinity of the center of the crystalline lens KL. The X-scanner XS deflects the light from the object arm over the object in the X-direction. At the start of the X-scan, the X-scanner XS assumes the initial position 2, which leads to the scan in the X-direction starting at the edge of the crystalline lens KL.

In FIG. 19c the 1×3 switch FOS routes the light to the object arm with the short optical fiber. If the light passes through this object arm then the light that is reflected in the posterior measurement region MB3 interferes with the light from the reference arm. The optical system O3, in combination with the scanning optical system SO, preferably focuses the light in the vicinity of the posterior reference surface RF3. The posterior reference surface RF3 is that surface in the posterior measurement region MB3 that has the same optical length as the reference arm. This means that the measurement sensitivity of the posterior measurement region MB3 is at a maximum on this surface RF3. The X-scanner XS deflects the light from the object arm over the object in the X-direction. At the start of the X-scan, the X-scanner XS assumes the initial position 3, which leads to the scan in the X-direction starting at the edge of the retina. In some applications it may suffice to only measure the axial distance to the retina for measuring the retina signals. In this case, the X-scanner and the Y-scanner are not moved.

For improved clarity, the angles of the initial positions 1, 2, and 3 in FIGS. 19a, 19b, and 19c have been sketched with exaggerated differences. In an actual design the angles between the optical axes of the three object arms would be significantly smaller so that the angular range of a commercially available X-scanner XS (e.g. a galvanometer scanner) suffices to adopt the three initial positions 1, 2, and 3.

The embodiment variant illustrated in FIGS. 19a, 19b, and 19c can also be operated using a 1×2 fiber-optic switch or a 1×4 fiber-optic switch in place of the 1×3 fiber-optic switch. Two measurement regions and two foci are generated with a 1×2 fiber-optic switch, while four measurement regions and four foci are generated with a 1×4 fiber-optic switch. It goes without saying that it is possible to make a device with a 1×n fiber-optic switch, which generates n measurement regions and n foci.

### EMBODIMENT VARIANT 18

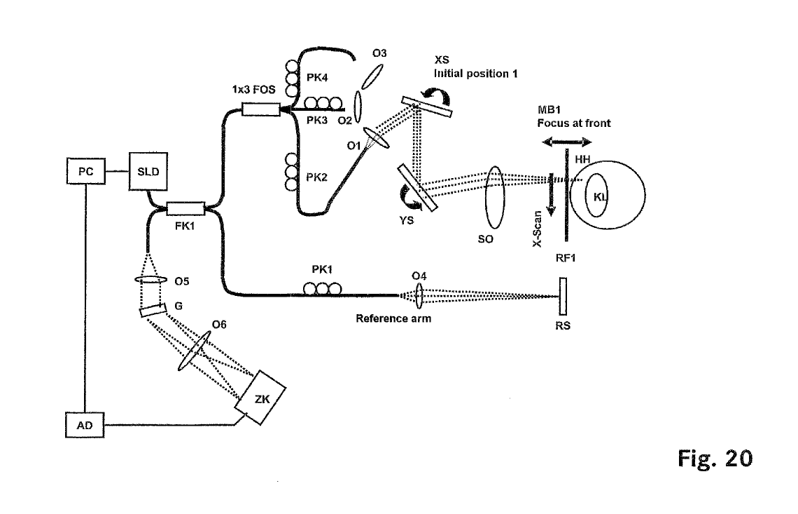

FIG. 20 shows an embodiment variant of a spectral short-coherent tomograph that utilizes the focus and measurement distance circuit utilized in FIGS. 19a, 19b, and 19c. In contrast to the embodiment variant illustrated in FIGS. 19a, 19b, and 19c, the embodiment shown in FIG. 20 uses a superluminescent diode SLD and a spectrometer consisting of a grating G, a line-scan camera ZK, and the optical systems O5 and O6. The light from the superluminescent diode SLD is routed to a 2×2 fiber-optic coupler FK1. The fiber-optic coupler FK1 divides the light into three object arms and one reference arm. The reference arm consists of a mono-mode fiber, a polarization controller PK1, an optical system O4, and a reference mirror RS. The optical system O4 focuses the reference beam onto the reference mirror RS. The reference mirror RS can optionally be embodied such that it can in a controlled fashion be displaced in the propagation direction of the reference beam in order to match one or more reference surfaces RF1, RF2, and/or RF3 precisely to the distance of the structure to be measured in the object arm. Displacing the reference mirror RS serves to maximize the measurement signal, which may be necessary in the case of very low measurement signals.

In FIG. 20, the 1×3 switch FOS routes the light to the object arm with the long optical fiber. If the light passes through this object arm, the light that is reflected in the anterior measurement region MB1 interferes with the light from the reference arm. The optical system O1, in conjunction with the scanning optical system SO, focuses the light preferably between the anterior corneal surface HH and the anterior surface of the crystalline lens KL. The anterior reference surface RF1 is that surface in the anterior measurement region MB1 that has the same optical length as the reference arm. This means that the measurement sensitivity of the anterior measurement region MB1 is at a maximum on this surface RF1. The X-scanner XS deflects the light from the object arm over the object in the X-direction. The movement direction of the measurement beam deflected by the X-scanner XS is indicated by the arrow of the X-scan. At the start of the X-scan, the X-scanner XS assumes the initial position 1, which leads to the scan in the X-direction starting at the edge of the cornea. The Y-scanner YS deflects the light from the object arm over the object in the Y-direction. A scanning optical system SO serves to deflect the measurement beams onto the eye such that they impinge on the anterior corneal surface at the desired angle. The scanning optical system will normally be selected such that the measurement beams are deflected telecentrically over the measurement object. The polarization controller PK2 is used to set the polarization of the beam reflected by the object such that the strongest possible interference signal is detected in the detection arm.

In the detection arm the optical system O5 brings the light emerging from the optical fiber to the grating G in a collimated fashion. The grating G diffracts the wavelengths contained in the spectrum of a broadband light source, e.g. a superluminescent diode SLD, in different directions. The optical system O6 images the wavelengths, which differ in the propagation direction, onto the line-scan camera at spatially separated points. Each pixel in the line-scan camera detects a narrow wavelength range from the spectrum of the superluminescent diode SLD. The output from the line-scan camera is digitized in an analog/digital converter AD. The digitized signal is Fourier transformed on a computer PC. The Fourier transform provides the reflections of the object as a function of their distance from the reference surface RF1. These reflections as a function of position are displayed on a monitor as an intensity pattern or as data values. The intensity pattern may be displayed 1-dimensionally (A-scan), 2-dimensionally (B-scan), or 3-dimensionally (C-scan).

The embodiment variant shown in FIG. 20 uses a 1×3 fiber-optic switch FOS resulting in three object arms that are used alternately. The three object arms allow the measurement in three measurement regions arranged one behind the other, wherein the focus is placed in the respective measurement region synchronously with the measurement-region switching. For reasons of simplicity, FIG. 20 only shows the beam path for the measurement of the anterior-most eye segment. Activating the central measurement region and posterior measurement region by the fiber-optic switch FOS has not been shown.

It goes without saying that variants are feasible in which use is made of a 1×2 fiber-optic switch, a 1×4 fiber-optic switch, or a 1×n fiber-optic switch, which produce two, four, or n object arms.

The embodiment variant shown in FIG. 20 of a spectral OCT may also be equipped with a different device for focus and distance switching than the one shown in FIG. 20. This is because all focus and distance switchings disclosed in this patent document operate in both spectral OCT instruments equipped with a spectrometer and OCT instruments equipped with a tunable light source SSOCT. More particularly, the object arm part of the spectral OCT shown in FIG. 20 may be replaced by a device for focus and distance switching as described e.g. in FIGS. 8a and 8b, or 21a and 21b, or 22a, 22b and 22c.

### EMBODIMENT VARIANT 19

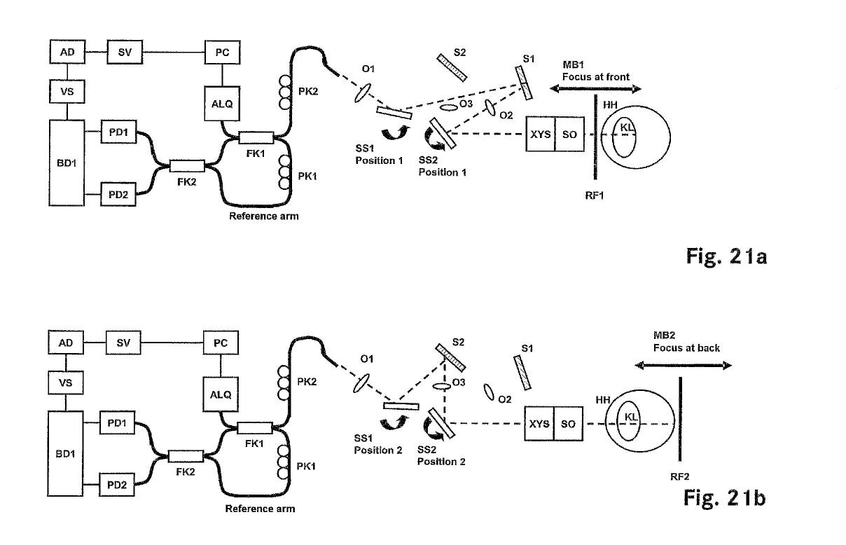

A further embodiment variant that synchronously displaces the focus and the measurement distance is illustrated in FIGS. 21a and 21b. The light from a tunable light source ALQ is conducted into a 2×2 fiber-optic coupler FK1. The fiber-optic coupler FK1 divides the light into the two object arms and one reference arm. The reference arm consists of a mono-mode optical fiber and a polarization controller PK1. The reference arm starts at the fiber-optic coupler FK1 and ends at the fiber-optic coupler FK2. The light from the reference arm interferes with the light from the object arm in the fiber-optic coupler FK2.

In the object arms there is a polarization controller PK2, a scanner mirror 1 SS1, a scanner mirror 2 SS2, an XY scanner XYS, a scanning optical system SO, and the stationary mirrors S1, S2, as well as the optical systems O1, O2, and O3. The scanner mirror 1 SS1 alternately routes the light to two different object arms. The two object arms differ in terms of the refractive indices of the two optical systems O2 and O3, as well as in terms of the optical length measured from the fiber-optic coupler FK1 to the anterior surface of the object. In FIGS. 21a and 21b the anterior surface of the object is the anterior corneal surface.

In FIG. 20a, the scanner mirror 1 SS1 deflects the light into the object arm with the long path in air.

The deflection at the correct angle only occurs at a specific position 1 of the scanner mirror 1 SS1 and the scanner mirror SS2. By way of example, the scanner mirrors can be galvanometer mirrors. If the light passes through this object arm, the light that is reflected in the anterior measurement region MB1 interferes with the light from the reference arm. The optical system O1, in combination with the optical system O2 and the scanning optical system SO, focuses the light preferably in the vicinity of the anterior surface of the crystalline lens KL. The anterior reference surface RF1 is that surface in the anterior measurement region MB1 that has the same optical length as the reference arm. This means that the measurement sensitivity of the anterior measurement region MB1 is at a maximum on this surface RF1. The XY scanner XYS deflects the light from the object arm over the object in the X-direction and in the Y-direction. A scanning optical system SO serves to deflect the measurement beams onto the object such that they impinge on the anterior corneal surface at the desired angle. The scanning optical system will normally be selected such that the measurement beams are deflected telecentrically over the measurement object. The polarization controllers PK1 and PK2 are used to set the polarization of the beam reflected by the object such that the strongest possible interference signal is detected in the detection arm consisting of the photodiodes PD1 and PD2, a balanced detection BD1, an amplifier stage VS, an analog/digital converter AD, and signal processing SV. The measurement signals are transmitted to a computer PC, which processes them further and provides them to the user as numerical values or as an image.

In FIG. 21b, the scanner mirror 1 SS1 deflects the light into the object arm with the short path in air. The deflection at the correct angle only occurs at a specific position 2 of the scanner mirror 1 SS1 and the scanner mirror SS2. If the light passes through this object arm, the light that is reflected in the posterior measurement region MB2 interferes with the light from the reference arm. The optical system O1, in conjunction with the optical system O3 and the scanning optical system SO, focuses the light in the vicinity of the posterior reference surface RF2.

### EMBODIMENT VARIANT 20

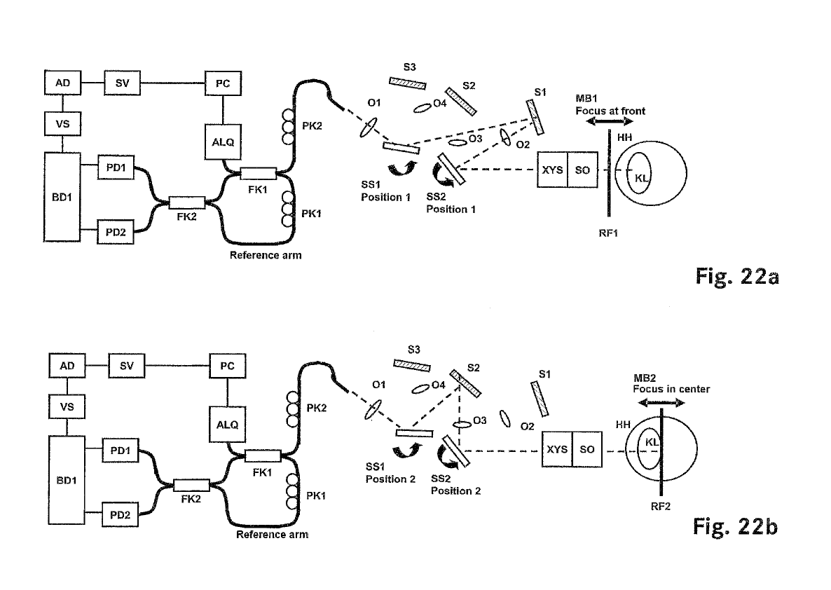

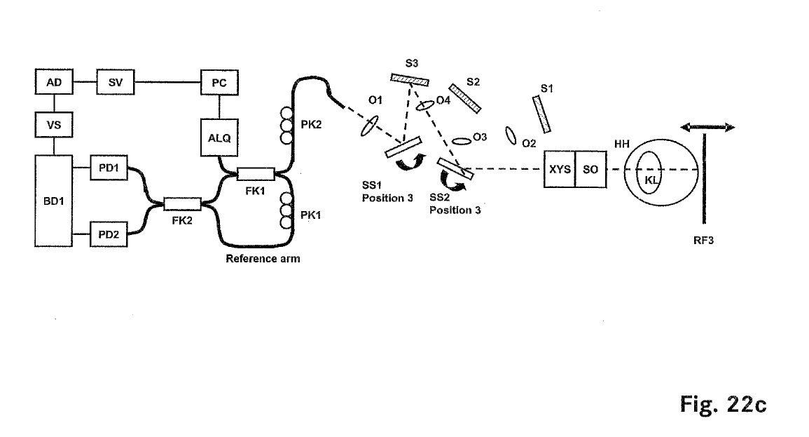

The embodiment variant illustrated in FIGS. 21a and 21b may also be operated with three stationary mirrors S1, S2, and S3 or n stationary mirrors in place of two stationary mirrors S1 and S2. Three measurement regions and three foci are generated with three mirrors, and n measurement regions and n foci are generated with n mirrors. An embodiment variant with three mirrors S1, S2, and S3 is illustrated in FIGS. 22a, 22b, and 22c.

In conclusion, it should be noted that according to the invention a device and a method is developed that allows a particularly efficient measurement, even in the case of objects with long axis lengths.

1. A device for establishing geometric values at least from a first region (MB1) and from a second region (MB3), distanced from the first region (MB1), of a transparent or diffusive object, comprising a coherence tomograph with an object arm, a reference arm, a detector arm, and a light source (ALQ) for emitting light, wherein the device has a first path, formed by the object arm and/or the reference arm, having a first optical path length and a second path having a second optical path length, along which the light emitted by the light source (ALQ) can propagate.

2. The device as claimed in claim 1, wherein the coherence tomograph is embodied as a frequency domain OCT, more particularly as an SSOCT or as a spectral OCT.

3. The device as claimed in claim 1, wherein the geometric value is a layer thickness, a length, a surface curvature, and/or a topography of the object.

4. The device as claimed in claim 1, wherein the object arm comprises a focus switch (FS).

5. The device as claimed in claim 1, wherein the first region (MB1) is an anterior region of an eye, more particularly the anterior corneal surface, and the second region (MB3) is a posterior region of the eye, more particularly the retina.

6. The device as claimed in claim 1, wherein the first path having the first optical path length is given by a first object arm and the second path having the second optical path length is given by a second object arm.

7. The device as claimed in claim 1, wherein the first optical path length is given by a first reference arm and the second optical path length is given by a second reference arm.

8. The device as claimed in claim 1, wherein the first optical path length is given by a first reference arm and the second optical path length is given by a first object arm and a third optical path length is given by a second reference arm and a fourth optical path length is given by a second object arm.

9. The device as claimed in claim 1, wherein it comprises an object arm or a reference arm with an optical element which can be pivoted in or out, wherein the first optical path length is given when the optical element is pivoted in and the second optical path length is given when the optical element is pivoted out.

10. The device as claimed in claim 1, wherein it has a first arm having a first optical path length and a second arm having a second optical path length, wherein the first and the second arm are respectively embodied as object arm or reference arm, and wherein one arm comprises an optical transformation element (PST1) for changing a property of the light, more particularly the wavelength or the polarization, and wherein the detector arm comprises an optical separation apparatus that corresponds to the optical transformation element.

11. A method for establishing geometric values at least from a first region (MB1) and from a second region (MB3), distanced from the first region (MB1), of a transparent or diffusive object, using a coherence tomograph with an object arm, a reference arm, a detector arm, and a light source (ALQ) for emitting light, wherein the light from the light source (ALQ) is guided over a first path having a first optical path length in the object arm and/or the reference arm in order to establish the geometric value of the first region (MB1) and the light from the light source is guided over a second path having a second optical path length in the object arm and/or the reference arm in order to establish the geometric value of the second region (MB3).

12. The method as claimed in claim 11, wherein the light is successively guided in a first object arm with the first path having the first optical path length and in a second object arm with the second path having the second optical path length.

13. The method as claimed in claim 11, wherein the light is guided in a first reference arm with the first path having the first optical path length and in a second reference arm with the second path having the second optical path length.

14. The method as claimed in claim 11, wherein the light is successively guided in a first reference arm with the first path having the first optical path length and in a first object arm with the second path having the second optical path length, and subsequently in a second reference arm with a third path having the third optical path length and in a second object arm with a fourth path having the fourth optical path length.

15. The method as claimed in claim 11, wherein an optical element is pivoted in and pivoted out in the object arm or in the reference arm, and so a first path having the first optical path length is set when the optical element is pivoted in and a second path having the second optical path length is set when the optical element is pivoted out, wherein the light is successively guided in the first path and in the second path.

16. The method as claimed in claim 11, wherein the light is simultaneously guided into two arms, more particularly an object arm and reference arm, with different optical path lengths, wherein one optical property of the light, more particularly the polarization or the wavelength, in a first arm differs from the same optical property in the second arm and wherein the light is separated in the detector arm by means of an optical separation apparatus on the basis of said optical property.

17. The device as claimed in claim 2, wherein the geometric value is a layer thickness, a length, a surface curvature, and/or a topography of the object.

18. The device as claimed in claim 2, wherein the object arm comprises a focus switch (FS).

19. The device as claimed in claim 3, wherein the object arm comprises a focus switch (FS).

20. The device as claimed in claim 2, wherein the first region (MB1) is an anterior region of an eye, more particularly the anterior corneal surface, and the second region (MB3) is a posterior region of the eye, more particularly the retina.
